(19) United States
(12) Patent Application Publication
(10) Pub. No.: US 2015/0103993 A1
(43) Pub. Date: Apr. 16, 2015

(54) COMMUNICATION CONTROL DEVICE, COMMUNICATION CONTROL METHOD, AND COMMUNICATION CONTROL SYSTEM

(71) Applicant: FUJITSU LIMITED, Kawasaki-shi (JP)

(72) Inventor: Hidehiko Fujimoto, Fukuoka (JP)

(73) Assignee: Fujitsu Limited, Kawasaki (JP)

(21) Appl. No.: 14/575,274

(22) Filed: Dec. 18, 2014

Related U.S. Application Data
(63) Continuation of application No. PCT/JP2012/066292, filed on Jun. 26, 2012.

(51) Int. Cl. H04Q 3/66

(52) U.S. Cl. CPC H04Q 3/66
USPC 379/221.03

(57) ABSTRACT

A communication control device include a call connection count management unit that acquires a call connection count that indicates a number of calls that are being processed by each of call control servers which performs a call process; a server stop control unit that transfers a call process that is allocated to a first call control server selected on the basis of the call connection count to another call control server, and that stops the first call control server when no call process allocated to the first call control server is present; and an assignment control unit that assigns, when the call control server that performs the call process associated with a processing request related to a call process is being stopped, the processing request to the other call control server to which the call process associated with the processing request is transferred.

### CROSS-REFERENCE TO RELATED APPLICATION

This application is a continuation of International Application No. PCT/JP2012/066292, filed on Jun. 26, 2012, the entire contents of which are incorporated herein by reference.

### FIELD

The embodiment discussed herein is related to a communication control device, a communication control method, and a communication control system.

### BACKGROUND

In recent years, in the communication service field, due to an increase in the number of broadband contractors and the diversification of the services, the traffic volume has been increasing. Due to this tendency, the performance that can cope with the future traffic volume is needed for servers used in the communication field.

In order to implement the needed performance described above, with a method of increasing the capacity of a single server, there is a limit to implement such performance. Furthermore, in recent years, there is a need for effective utilization of facilities by gradually increasing the traffic volume from a small start or there is a need for electrical power saving. In this state, only using a conventional active/standby (ACT/SBY) function or a dual structure does not meet a requirement for the server. Accordingly, it has been proposed to improve the performance and the size of the system by using a communication control system based on a plurality of servers.

Because of this, there is a conventional technology that calculates, by using the number of processes for each server calculated from the maximum number of processing requests from a client per unit time, the number of servers needed to perform a currently requested process and that determines whether a server that can be stopped or a server that needs to be started up is present.

Furthermore, there is a conventional technology that increases or decreases the number of operating servers by allocating requests, in accordance with the priority of the servers, starting from the server that has a high priority until the number of operating servers reaches a threshold.
Patent Document 1: Japanese Laid-open Patent
Publication No. 2011-015196
Patent Document 2: Japanese Laid-open Patent Publication No. 2011-013870

However, the conventional technology that stops or starts up a server on the basis of the number of servers needed to perform a process on a request is not able to stop the servers until all of the servers complete the process on a continuous processing request for the server that is to be stopped. Accordingly, it is difficult to effectively implement the electrical power saving. In particular, if a server that performs call control is used, because the processing time varies in accordance with the use state of a user, the control aiming at the electrical power saving is not appropriately performed. Furthermore, with the conventional technology that allocates requests in accordance with the priority, if the processing load becomes temporarily high and a process is allocated to a low priority server, the low priority server, in which the allocated process still remains even if the processing load is decreased, does not stop until the end of the process.

### SUMMARY

According to an aspect of an embodiment, a communication control device includes: a call connection count management unit that acquires a call connection count that indicates a number of calls that are being processed by each of a plurality of call control servers which performs a call process; a server stop control unit that selects, on the basis of the call connection count for each of the call control servers, a first call control server from among the call control servers, that transfers a call process that is allocated to the first call control server to another call control server, and that stops the first call control server when no call process allocated to the first call control server is present; and an assignment control unit that receives a processing request related to a call process and that assigns, when the call control server that performs the call process associated with the processing request is being stopped by the server stop control unit, the processing request to the other call control server to which the call process associated with the processing request is transferred by the server stop control unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a communication control system according to an embodiment;

FIG. 2 is a schematic diagram illustrating an example of call information;

FIG. 3 is a schematic diagram illustrating an example of server management information;

FIG. 4 is a schematic diagram illustrating an example of a call connection information list;

FIG. 5 is a schematic diagram illustrating an example of a server state management table;

FIG. 6 is a schematic diagram illustrating call processes managed by call control servers, respectively, before the moving of the call processes occurs;

FIG. 7 is a schematic diagram illustrating the call processes managed by the call control servers, respectively, after the moving of the call processes have occurred;

FIG. 8 is a schematic diagram illustrating the call processes managed by the call control servers, respectively, before the call processes are returned;

FIG. 9 is a schematic diagram illustrating the call processes managed by the call control servers, respectively, after the call processes are returned;

FIG. 10 is a schematic diagram illustrating an example configuration of a communication control device when the device is constituted by two servers;

FIG. 11 is a sequence diagram illustrating a process performed until communication is established;

FIG. 12 is a sequence diagram illustrating a transfer process of transferring a call process;

FIG. 13 is a sequence diagram illustrating a call process after the transfer;

FIG. 14 is a sequence diagram illustrating a return process of returning a call process;

FIG. 15 is a sequence diagram illustrating a call process after the call process has been returned;

FIG. 16 is a flowchart illustrating the flow of a determination process that determines a stop target server and a transfer destination server;

FIG. 17 is a schematic diagram illustrating an example of the state of the call connection information list before the transfer;

FIG. 18 is a schematic diagram illustrating an example of a call connection counts sort result in ascending order;

FIG. 19 is a schematic diagram illustrating an example of the calculation result obtained when the determination process that determines the stop target server and the transfer destination server is performed;

FIG. 20 is a flowchart illustrating the flow of a determination process that determines a call control server to which a transferred call process is to be returned;

FIG. 21 is a schematic diagram illustrating an example of the state of the call connection information list before the call process is returned;

FIG. 22 is a schematic diagram illustrating an example of the calculation result obtained when the determination process that determines the call control server to which the call process is to be returned is performed;

FIG. 23 is a schematic diagram illustrating the transition of the server management information;

FIG. 24 is a schematic diagram illustrating the transition of the call information;

FIG. 25 is a schematic diagram illustrating the transition of the server state management table;

FIG. 26A is a schematic diagram illustrating an example of the state of call connection when a conventional technology is used;

FIG. 26B is a schematic diagram illustrating an example of the state of call connection counts when the communication control device according to the embodiment is used;

FIG. 27A is a schematic diagram illustrating another example of the state of call connection when the conventional technology is used;

FIG. 27B is a schematic diagram illustrating another example of the state of call connection counts when the communication control device according to the embodiment is used; and

FIG. 28 is a block diagram illustrating the hardware configuration of the communication control device.

### DESCRIPTION OF EMBODIMENTS

Preferred embodiments of the present invention will be explained with reference to accompanying drawings. The communication control device, the communication control method, and the communication control system disclosed in the present invention are not limited to the embodiment described below.

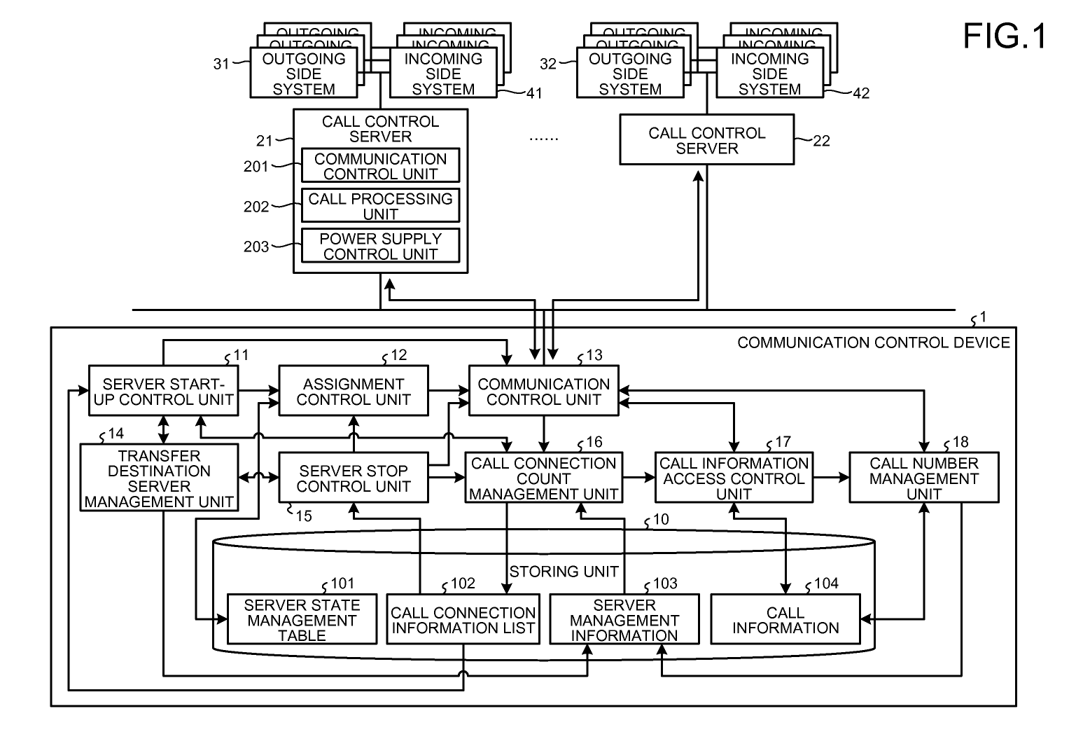

FIG. 1 is a block diagram illustrating a communication control system according to an embodiment. The communication control system according to the embodiment includes a communication control device 1 and call control servers 21 and 22. FIG. 1 illustrates only two call control servers, i.e., the call control servers 21 and 22; however, the number of the call control servers may also be three or more. In a description below, when the call control servers are not distinguished, the servers will be simply referred to as a “call control server 20”. The communication control device 1 is connected to the call control server 20 via a network.

Furthermore, the combinations of outgoing side systems 31 and incoming side systems 41 indicate systems in which call processes between the systems are performed by the call control server 21. Furthermore, the combinations of outgoing side systems 32 and incoming side systems 42 indicate systems in which call processes between the systems are performed by the call control server 22. In order to represent the association relationship with the call control server that manages a call process, FIG. 1 illustrates the units such that the call control servers 21 and 22, the outgoing side systems 31 and 32, and the incoming side systems 41 and 42 are connected respectively. However, the outgoing side systems 31 and 32 and the incoming side systems 41 and 42 may also be connected to the network that connects the communication control device 1 to the call control servers 21 and 22. In a description below, when the outgoing side systems are not distinguished, the systems will be simply referred to as an “outgoing side system 30”. Furthermore, when the incoming side systems are not distinguished, the systems will be simply referred to as an “incoming side system 40”.

The communication control device 1 includes a storing unit 10, a server start-up control unit 11, an assignment control unit 12, a communication control unit 13, a transfer destination server management unit 14, a server stop control unit 15, a call connection count management unit 16, a call information access control unit 17, and a call number management unit 18.

The storing unit 10 stores therein the format of a server state management table 101, a call connection information list 102, server management information 103, and call information 104.

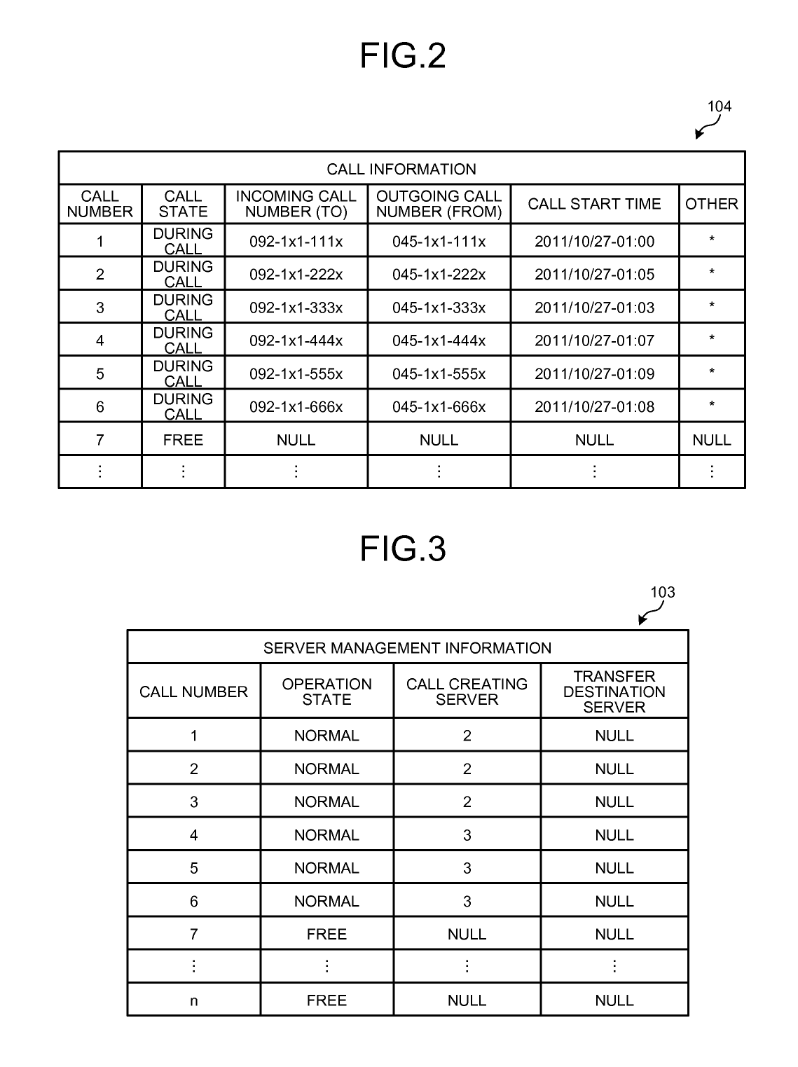

FIG. 2 is a schematic diagram illustrating an example of call information. For example, as illustrated in FIG. 2, the call information 104 is a table in which the call number, the call state, the incoming call number, the outgoing call number, the call start time, and the other information are registered in an associated manner. The call state is information on the call sate indicating whether a call to which a call number is allocated is during a call. The incoming call number is information that indicates the telephone number of a device on the incoming side. The outgoing call number is information that indicates the telephone number of a device on the outgoing side. The call start time is information that indicates the time at which a call is started between the device on the outgoing side and the device on the incoming side. The other information is information represented by “etc.” in FIG. 2 and is various kinds of information related to a call.

FIG. 3 is a schematic diagram illustrating an example of server management information. For example, as illustrated in FIG. 3, the server management information 103 is a table in which the call number, the operation state, the call creating server, and the transfer destination server are registered in an associated manner. The operation state is information that indicates whether a call process of a call to which a call number is allocated is managed by a call control server that has created the call or that indicates whether the call process is transferred from a call creating server to another call control server and is managed by the call control server at the transfer destination. Furthermore, the call creating server is information on the call control server that has created a call to which a call number is allocated. In a description below, the call control server that has created a call may sometimes be referred to as a “call creating server”. The transfer destination server is information on a call control server at the destination to which a call process is transferred when the call process is transferred from a call creating server, which will be described later, to the other call control server. In a description below, a call control server to which a call process is transferred may also be referred to as a “transfer destination server”. In the server management information 103, the operation state that is associated with the call number that is not allocated to a call is set to “free” and the call creating server and the transfer destination server are set to “NULL”.

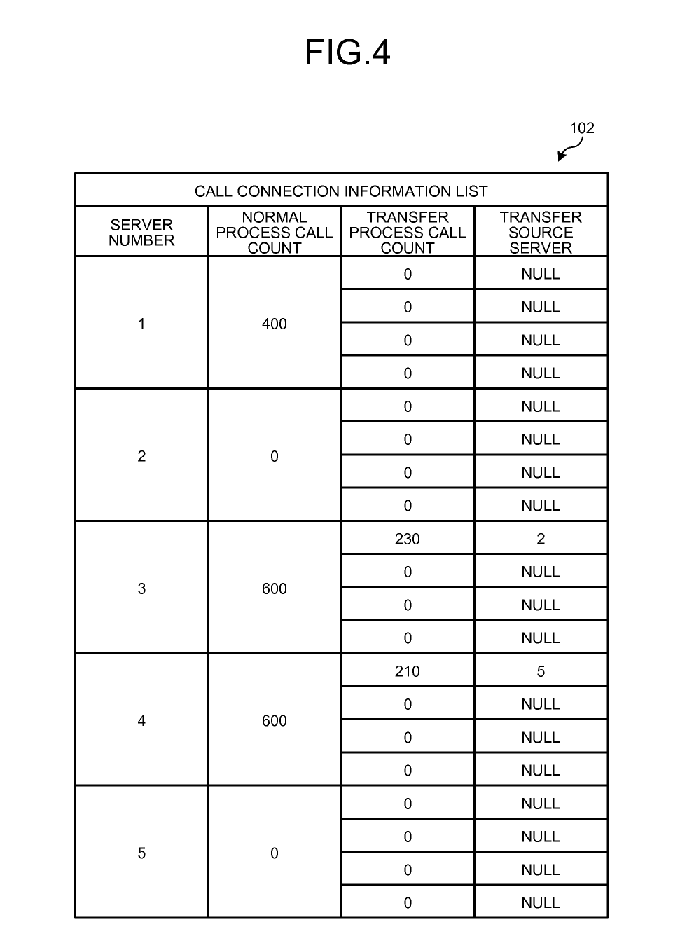

FIG. 4 is a schematic diagram illustrating an example of a call connection information list. For example, as illustrated in FIG. 4, the call connection information list 102 is a table in which the server number, the normal process call count, the transfer process call count, and the transfer source server are registered in an associated manner. The server number is identification information on each of the call control servers 20. The normal process call count is the number of calls created and managed by the call control server 20 that has the associated server number. The transfer process call count is the number of calls, for each server at the transfer source of a call whose process has been transferred to the call control server 20 that has the associated server number. The transfer source server is the identification information on the call control server 20 from which a call process has been transferred to the call control server 20 that has the associated server number. The call connection information list 102 is created by a call connection count management unit 16, which will be described later.

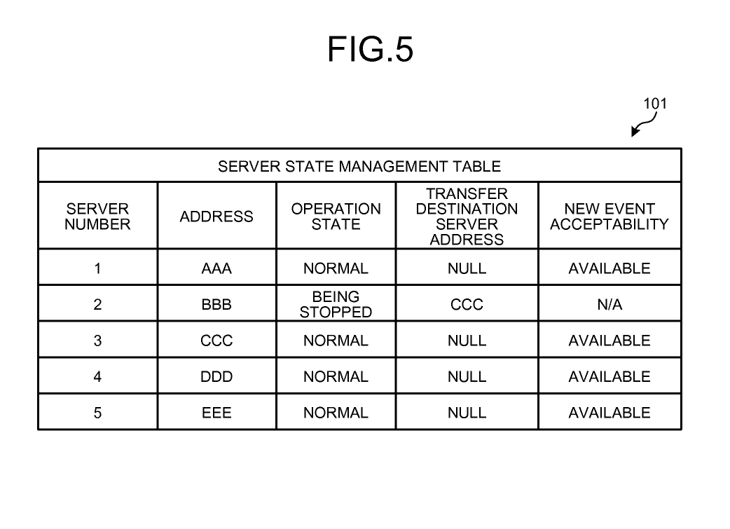

FIG. 5 is a schematic diagram illustrating an example of a server state management table. For example, as illustrated in FIG. 5, the server state management table 101 is a table in which the server number, the address, the operation state, the transfer destination server address, and the new event acceptability are registered in an associated manner. The server number is the identification information on each of the call control servers 20. The operation state is information that indicates whether the call control server 20 that has the associated server number is in operation or is being stopped. The transfer destination server address is the address of the call control server 20 to which the call process that was included in the call control server 20 with the associated server number has been transferred. The new event acceptability is the information that indicates whether the call control server 20 that has the associated server number can receive a new event.

The communication control unit 13 receives data from the call control server 20, the outgoing side system 30, and the incoming side system 40 and then outputs the data to each unit that performs a process on the received data. Furthermore, the communication control unit 13 receives data output from each unit and then sends the data to the call control server 20, the outgoing side system 30, and the incoming side system 40. In this way, in practice, each of the units in the communication control device 1 sends and receives data to and from the call control server 20, the outgoing side system 30, and the incoming side system 40 via the communication control unit 13; however, in a description below, for convenience of explanation, a description will sometimes be given as if each of the units sends and receives data to and from the call control server 20.

The call number management unit 18 receives a call number acquisition request from the call control server 20 that has received a request for call setting from the outgoing side system 30. The call number management unit 18 checks the call state of the call information 104 and specifies an unused call number. The call number management unit 18 allocates an unused call number in response to the call number acquisition request received from the call control server 20. Then, the call number management unit 18 sends the allocated call number to the call control server 20 that has sent the call number acquisition request.

Furthermore, the call number management unit 18 registers “normal” in the item of the operation state that is associated with the allocated call number in the server management information 103. Furthermore, in the item of the call creating server associated with the allocated call number in the server management information 103, the call number management unit 18 registers the identification information on the call control server 20 that has sent the call number.

The call information access control unit 17 has an exclusive access control function that prevents call information managed by one of the call control servers 20 from being accessed by the other call control servers 20. Then, the call information access control unit 17 provides the call control server 20 with a function of referring to or updating call information by being accessed in accordance with the call number.

For example, when a communication call is established, the call information access control unit 17 receives, from the call control server 20, the call number allocated by the call number management unit 18 and the information, such as the outgoing call number or the incoming call number that is associated with the allocated call number. Then, the call information access control unit 17 registers the information, such as the received outgoing call number or the incoming call number, in the call information 104. Furthermore, the call information access control unit 17 changes the call state in the call information 104 associated with the received call number to an outgoing call state. Thereafter, if the call information access control unit 17 receives a call information read request from the call control server 20, the call information access control unit 17 reads the call information 104 and sends the read information to the call control server 20. Furthermore, after the transition of the call state, the call information access control unit 17 receives a call information write request from the call control server 20. Then, the call information access control unit 17 changes the call state of the call information 104 such that the transition state of the call is indicated. Then, if the state shifts to a communication call state, the call information access control unit 17 changes the call state in the call information 104 to “during a call”.

Furthermore, similarly, when a communication call is ended, if the call information access control unit 17 receives a call information read request from the call control server 20, the call information access control unit 17 reads the call information 104 and sends the read information to the call control server 20. Furthermore, after the transition of the call state, the call information access control unit 17 receives a call information write request from the call control server 20. Then, the call information access control unit 17 changes the call state in the call information 104 such that the transition state of the call is indicated. If disconnection of the communication call has been successful, the call information access control unit 17 changes the call state, in the call information 104, that is associated with the call number of the call that has successfully been disconnected to “free” and then deletes the incoming call number, the outgoing call number, the call start time, and the other information that are associated with the call number from the call information 104.

When the call connection count management unit 16 receives a call connection information acquisition request from the server stop control unit 15, which will be described later, the call connection count management unit 16 extracts call processes in which the operation state in the server management information 103 is “normal” and aggregates the call processes for each call creating server. Then, the call connection count management unit 16 registers the result of the aggregation in the normal process call count associated with each call control server in the call connection information list 102. Furthermore, the call connection count management unit 16 extracts call processes in which the operation state in the server management information 103 is a “transfer” and aggregates the call processes for each transfer destination server and for each call creating server. Then, the call connection count management unit 16 specifies the call control server 20 associated with each of the aggregated transfer destination servers in the call connection information list 102. In the item, in the server management information 103, of the transfer source server number that is associated with the call control server specified in the call connection information list 102, the call connection count management unit 16 registers the identification information on the call creating server that uses the specified call control server 20 as a transfer destination server. Furthermore, the call connection count management unit 16 registers the result of the aggregation in the item of the transfer process call count that is associated with the registered transfer source server number.

The server stop control unit 15 periodically sends a call connection information acquisition request to the call connection count management unit 16. At this point, if the period in which a call connection information acquisition request is sent is short, the number of times a server is stopped can be increased; therefore, the electrical power saving can be further improved. However, the load applied to the communication control device becomes high. Accordingly, the period in which the call connection information acquisition request is sent is preferably determined in accordance with the operation state.

The server stop control unit 15 refers to the call connection information list updated by the call connection count management unit 16 and determines whether a server that can be stopped is present. In the following, the determination of a server, performed by the server stop control unit 15, that can be stopped will be described in detail.

The server stop control unit 15 stores therein, in advance, a server stop monitor threshold that is used to determine whether a server can be stopped. For example, the server stop monitor threshold may be set to the value of 20% of the maximum amount of the load. Then, the server stop control unit 15 acquires, from the call connection information list 102, the normal process call count and the transfer process call count managed by each of the call control servers 20. Then, the server stop control unit 15 calculates, for each call control server 20, sum of the number of the normal processes and the number of the transfer processes and calculates a call connection count. Then, the server stop control unit 15 sorts the call control servers 20 in ascending order of the call connection counts. Then, the server stop control unit 15 selects, one by one, a check target server from the top to the lowest rank and repeatedly performs the following process. Namely, from among the call control servers 20 ranking from the second to the lowest check target servers, the server stop control unit 15 determines whether there is any server that does not exceed the server stop monitor threshold even if a call connection count of a check target server is added to the call connection count that is managed by that server. If there is any server that does not exceed the server stop monitor threshold even if a call connection count of a check target server is added to the call connection count that is managed by that server, the server stop control unit 15 determines that the check target server is the stop target server. This stop target server corresponds to an example of a “first call control server”. Then, from among the servers that do not exceed the server stop monitor threshold even if a call connection count of a stop target server is added, the server stop control unit 15 determines that the lowest rank of the call control server 20 is a transfer destination server. Then, the server stop control unit 15 calculates, as the calculation result, the number of call processes that are to be managed by each of the call control servers 20 due to the transfer of the call process. The server stop control unit 15 holds the calculation result even when the check target server is transferred to the other call control server 20 and updates the calculation result every time a transfer of a call process occurs.

When the checking whether a server can be stopped has been completed for all of the call control servers 20, the server stop control unit 15 notifies the assignment control unit 12 that the assignment of the stop target server is to be stopped.

Furthermore, the server stop control unit 15 notifies the transfer destination server management unit 14 that the operation state of the stop target server in the server management information 103 is to be changed to “being stopped” and the transfer destination server is to be registered.

When the completion of the update of the server management information 103 is received from the transfer destination server management unit 14, the server stop control unit 15 notifies the assignment control unit 12 of the transfer destination server to which the call that was managed by the stop target server is to be transferred and instructs the assignment control unit 12 to update the server state management table 101.

Then, the server stop control unit 15 sends a stop instruction to the call control server 20 that is the stop target server.

The server start-up control unit 11 periodically sends a call connection information acquisition request to the call connection count management unit 16. At this point, if the period in which a call connection information acquisition request is sent is short, the number of times a server is started up can be increased; therefore, it is possible to prevent the server from becoming a high load server. However, the load applied to the communication control device 1 becomes high. Accordingly, the period in which the call connection information acquisition request is sent is preferably determined in accordance with the operation state.

The server start-up control unit 11 refers to the call connection information list 102 that has been updated by the call connection count management unit 16 and determines whether a stopped state server is present. If a server that is being stopped is present, the server start-up control unit 11 determines whether there is the call control server 20 with a load that exceeds a server start-up monitor threshold that is stored in advance (hereinafter, referred to as a “high load server”). At this point, the server start-up monitor threshold is set to a value lower than the server stop monitor threshold. For example, if the server stop monitor threshold is set to a value of 20% of the maximum amount of the load, the server start-up monitor threshold may be set to a value of 50% of the maximum amount of the load.

If a high load server is present, the server start-up control unit 11 determines that the call process that has been transferred to the high load server is returned to the transfer source server. The server start-up control unit 11 notifies the transfer destination server management unit 14 of an update request for the server management information.

When a completion notification of the update of the server management information 103 is received from the transfer destination server management unit 14, the server start-up control unit 11 sends a start-up instruction to the call control server 20 that is the transfer source server to which the call process is to be returned.

Furthermore, the server start-up control unit 11 notifies the transfer destination server management unit 14 of the information on the high load server and then instructs the assignment control unit 12 to update the server state management table 101.

Furthermore, the server start-up control unit 11 instructs the transfer destination server management unit 14 to change the operation state of the transfer source server, in the server management information 103, to which the call process is returned to “normal” and instructs to return the transfer destination server to “NULL”.

The transfer destination server management unit 14 receives, from the server stop control unit 15, a request to change the operation state of the stop target server in the server management information 103 to “being stopped” and a request to register the transfer destination server. Then, the transfer destination server management unit 14 changes the operation state of the stop target server in the server management information 103 to “being stopped” and then registers the identification information on the transfer destination server to which a call has been transferred from the stop target server. Thereafter, the transfer destination server management unit 14 outputs the completion notification of the update of the server management information 103 to the server stop control unit 15.

Furthermore, the transfer destination server management unit 14 receives, from the server stop control unit 15, a request to change the operation state of the transfer source server, to which the call process is returned, to “normal” and a request to return the transfer destination server to “NULL” in the server management information 103. Then, the transfer destination server management unit 14 changes the operation state of the transfer source server, to which the call process is returned, to “normal” and returns the transfer destination server to “NULL” in the server management information 103. Thereafter, the transfer destination server management unit 14 outputs a completion notification of the update of the server management information 103 to the server start-up control unit 11.

The assignment control unit 12 receives a request for call setting from the outgoing side system 30. Then, the assignment control unit 12 selects a server, from among the call control servers 20, to which a call is allocated. Then, the assignment control unit 12 notifies the selected call control server 20 of the information on the outgoing side system 30 and the information on the incoming side system 40 and then performs the call setting on the selected call control server 20.

The assignment control unit 12 receives an instruction to stop assigning a new event from the server stop control unit 15. Then, the assignment control unit 12 stops assigning an event, such as the call setting, that is requested after that to the stop target server.

Then, the assignment control unit 12 receives, from the server stop control unit 15, a notification of the transfer destination server to which the call process that was managed by the stop target server is to be transferred and an instruction to update the server state management table 101. Then, the assignment control unit 12 changes the operation state of the stop target server in the server state management table 101 to “being stopped”. Furthermore, the assignment control unit 12 writes, in the transfer destination server address, the address of the transfer destination server to which the call process that was managed by the stop target server is to be transferred and then changes the new event acceptability to “not available”.

Furthermore, the assignment control unit 12 receives, from the server start-up control unit 11, an instruction to change the operation state of the transfer source server, to which the call process is to be returned, in the server management information 103 to “normal” and instruction to return the transfer destination server to “NULL”. Then, in the server state management table 101, the assignment control unit 12 changes the operation state of the transfer source server to which the call process is to be returned to “in operation”, returns the transfer destination server address to “NULL”, and changes the new event acceptability to “available”.

In the following, a call control server will be described. In a description below, the call control server 21 will be described as an example; however, all of the call control servers 20 have the same function. The call control server 21 includes a communication control unit 201, a call processing unit 202, and a power supply control unit 203.

The communication control unit 201 controls communication among the communication control device 1, the outgoing side system 30, and the incoming side system 40.

The call processing unit 202 performs a call process that is set by the communication control device 1. For example, the call processing unit 202 creates call information that is to be sent to the communication control device 1 and then sends the call information. Furthermore, the call processing unit 202 creates a signal that is to be sent to the outgoing side system 30 or the incoming side system 40 and then sends the signal. When the call processing unit 202 creates a signal to be sent to the outgoing side system 30 or the incoming side system 40, the call processing unit 202 edits the Via header or the Record-Route header of the signal such that the signal is to be sent via the assignment control unit 12 in the communication control device 1.

In response to a stop instruction from the server stop control unit 15 in the communication control device 1, the power supply control unit 203 starts, the stop process on the call control server 21 and then turns off the power supply. Furthermore, in response to a start-up instruction received from the server start-up control unit 11 in the communication control device 1, the power supply control unit 203 turns on the power supply of the call control server 21 and then starts a start process. The power supply control unit 203 corresponds to an example of a “stop control unit”.

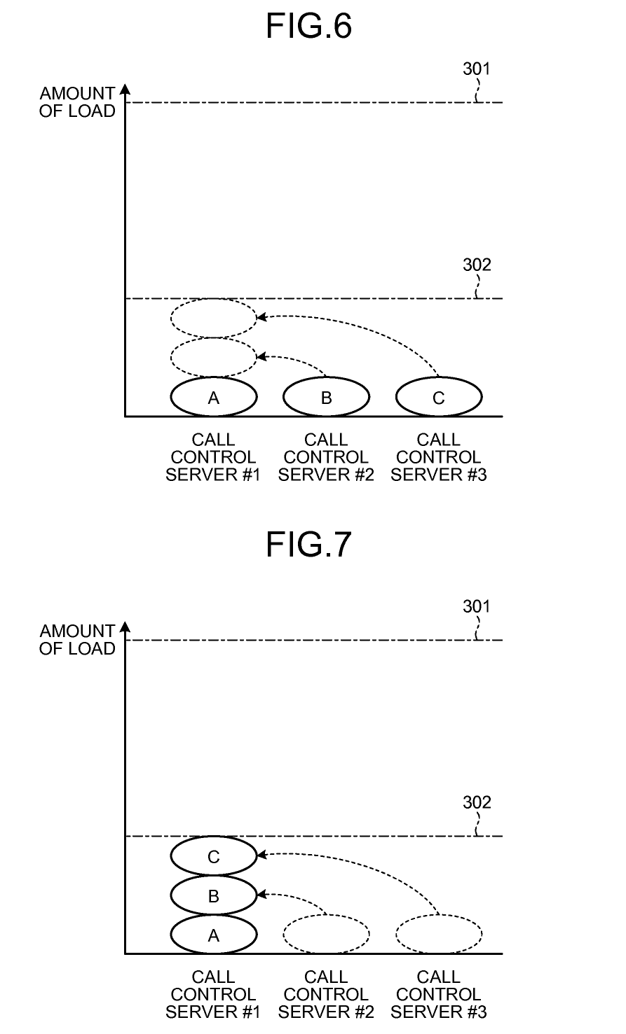

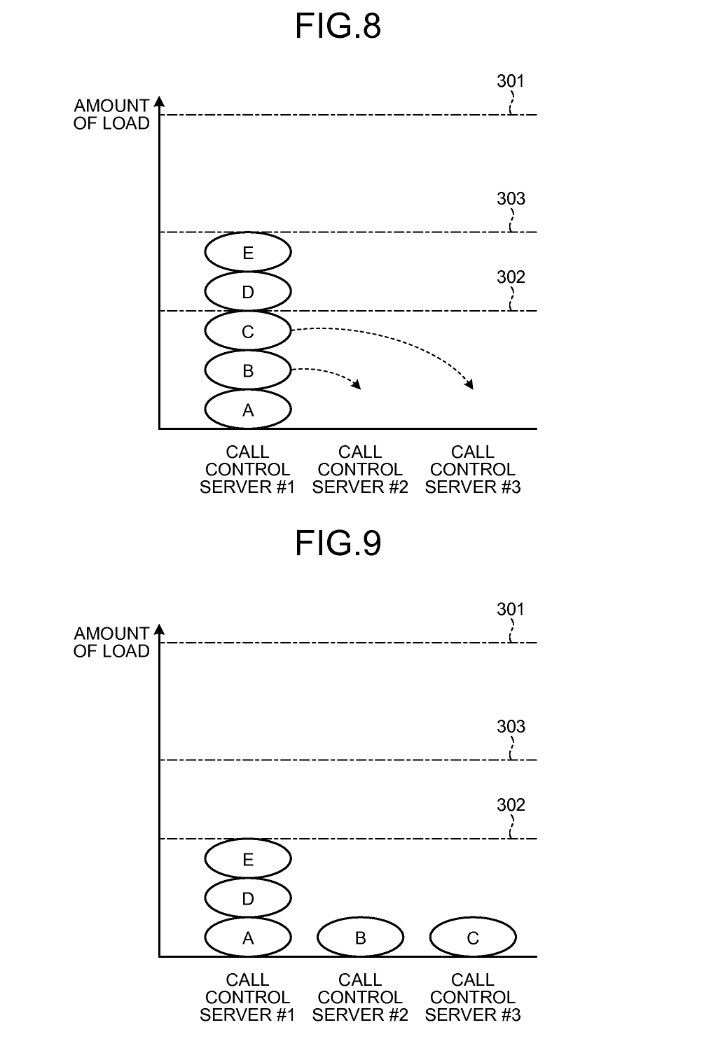

In the following, the outline of a transfer process of a call process and the outline of a return process of a call process will be described again with reference to FIGS. 6 to 9. FIG. 6 is a schematic diagram illustrating call processes managed by call control servers, respectively, before the moving of the call processes occurs. FIG. 7 is a schematic diagram illustrating the call processes managed by the call control servers, respectively, after the moving of the call processes have occurred. FIG. 8 is a schematic diagram illustrating the call processes managed by the call control servers, respectively, before the call processes are returned. FIG. 9 is a schematic diagram illustrating the call processes managed by the call control servers, respectively, after the call processes are returned. Each of the vertical axes illustrated in FIGS. 6 to 9 represents an amount of the load applied to a call control server that is associated with the number of the call processes and each of the horizontal axes represents each of the call control servers 20. In a description below, a description will be given of a case in which three call control servers 20, i.e., call control servers #1 to #3, are present. Furthermore, in a description below, for convenience of description, a description of a process for determining the call control server 20 to which a call process is transferred on the basis of the sorting described above will be omitted and a description will be given of a case in which the call processes of the call control servers #2 and #3 are transferred to the call control server #1.

The server stop control unit 15 stores therein, in advance, for example, a server stop monitor threshold 302 illustrated in FIG. 6 as a threshold for determining whether a server can be stopped. The maximum amount of a load 301 is a value that represents the maximum amount of the load that can be applied to the call control server 20. The server stop monitor threshold 302 is a value lower than the maximum amount of the load 301. In the state illustrated in FIG. 6, the call control server #1 manages a call process A, the call control server #2 manages a call process B, and a call control server #3 manages a call process C.

Then, the server stop control unit 15 determines, if the call processes managed by the call control servers #2 and #3 are transferred to the call control server #1, whether the amount of the load applied to the call control server #1 exceeds the server stop monitor threshold 302. If the amount of the load applied to the call control server #1 does not exceed the server stop monitor threshold 302, the server stop control unit 15 determines that both the call control servers #2 and #3 are the stop target servers. At this point, as illustrated by the dotted line in FIG. 6, even if the call process B and the call process C are added to the call process A that is managed by the call control server #1, the amount of the load does not exceeds the server stop monitor threshold 302. Accordingly, the server stop control unit 15 determines to move the call processes B and C managed by the call control servers #2 and #3, respectively, to the call control server #1 and determines to stop the call control servers #2 and #3.

Then, the server stop control unit 15 sends, to the assignment control unit 12, a notification indicating that the call process B and the call process C managed by the call control servers #2 and #3, respectively, are transferred to the call control server #1 and a notification of an instruction to update the server state management table 101. In response to the notification received from the server stop control unit 15, the assignment control unit 12 changes the operation state of each of the call control servers #2 and #3 in the server state management table 101 to the stopped state.

Furthermore, the assignment control unit 12 writes the address of the call control server #1 into the address of the transfer destination server for the call process B and the call process C that are managed by the call control servers #2 and #3, respectively. Consequently, after this, the assignment control unit 12 sends the processes that were managed by the call process B and the call process C to the call control server #1. Namely, as illustrated in FIG. 7, the call process B and the call process C managed by the call control servers #2 and #3, respectively, are transferred to the call control server #1.

Then, it is assumed that, in the state illustrated in FIG. 7, for example, a new call is set in the call control server #1 and the call process D and the call process E are managed by the call control server #1 and the state shifts to the state illustrated in FIG. 8. In such a case, the amount of the load applied to the call control server #1 becomes equal to or greater than a server start-up monitor threshold 303 and becomes a high load server. Accordingly, the server start-up control unit 11 determines that the call process B and the call process C that are transferred to the call control server #1 are returned to the call control servers #2 and #3 that are the transfer source servers.

Then, the server start-up control unit 11 sends a notification to the assignment control unit 12 that the call process B and the call process C that are managed by the call control server #1 are returned to the call control servers #2 and #3, respectively, and a notification to instruct to update the server state management table 101. In response to the notification from the server start-up control unit 11, in the server state management table 101, the assignment control unit 12 returns the operation state of the call control servers #2 and #3 to “normal” and, furthermore, returns the transfer destination server address of each of the call control servers #2 and #3 to “NULL”. Accordingly, the assignment control unit 12 sends each of the processes of the call process B performed after that to the call control server #2 and sends each of the processes of the call process C to the server #3. Namely, as illustrated in FIG. 9, the call process B and the call process C are returned to the call control servers #2 and #3 and thus the amount of the load applied to the call control server #1 can be reduced.

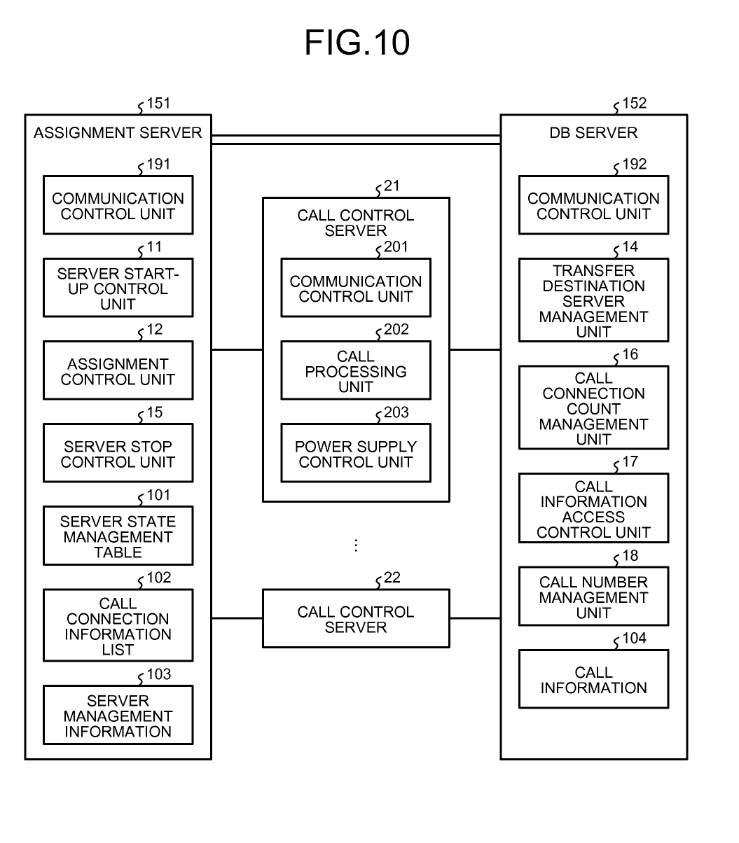

In the following, a communication system that is constituted by separating the communication control device 1 into an assignment server 151 and a database (DB) server 152 will be described with reference to FIG. 10. FIG. 10 is a schematic diagram illustrating an example configuration of a communication control device when the device is constituted by two servers.

The assignment server 151 includes the server start-up control unit 11, the assignment control unit 12, the server stop control unit 15, and a communication control unit 191. Furthermore, the assignment server 151 stores therein the server state management table 101, the call connection information list 102, and the server management information 103. The assignment server 151 is a server that has a function of assigning a call process to the call control servers 20.

The DB server 152 includes the transfer destination server management unit 14, the call connection count management unit 16, the call information access control unit 17, the call number management unit 18, and a communication control unit 192. Furthermore, the DB server 152 stores therein the call information 104. The DB server 152 is a server that has a function of managing the database in which the call information is registered.

Furthermore, in FIG. 10, the units having the same reference numerals as those illustrated in FIG. 1 have the same function. However, because the server is separated into two, the communication control unit 13 illustrated in FIG. 1 is separated into the communication control unit 191 in the assignment server 151 and the communication control unit 192 in the DB server 152.

In this way, as illustrated in FIG. 10, the communication control device 1 may be separated into two servers or more numbers of the servers. Furthermore, the method of separating the function is not limited to the example illustrated in FIG. 10, such as which function is performed by which server is not particularly limited.

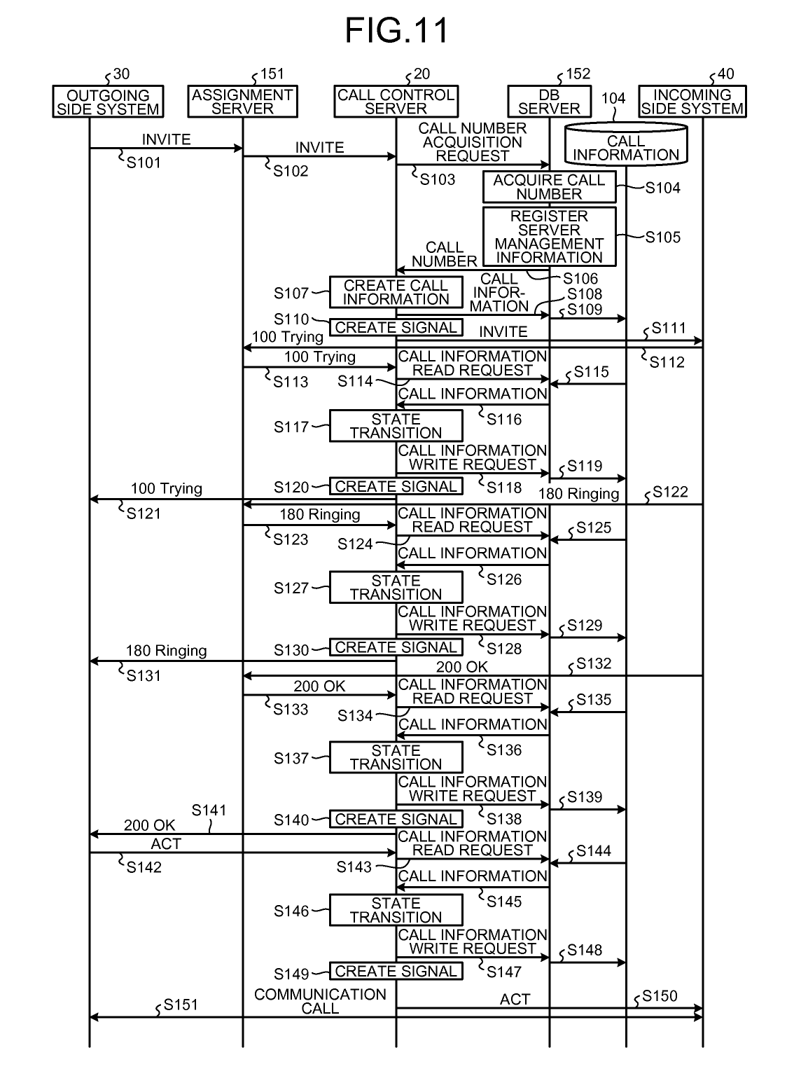

In the following, the flow of a process until communication is established will be described with reference to FIG. 11 by using an example of a communication information system illustrated in FIG. 10. FIG. 11 is a sequence diagram illustrating a process performed until communication is established.

The outgoing side system 30 request a communication call and sends, to the assignment server 151, INVITE that is a call setting request for a call to be set (Step S101).

The assignment server 151 receives INVITE from the outgoing side system 30. Then, the assignment control unit 12 in the assignment server 151 selects one of the call control servers 20 to which the call is set and then sends INVITE to the selected call control server 20 (Step S102).

The call processing unit 202 in the call control server 20 receives INVITE from the assignment server 151. Then, the call processing unit 202 sends a call number acquisition request to the DB server 152 (Step S103).

The DB server 152 receives the call number acquisition request from the call processing unit 202 in the call control server 20. Then, the call number management unit 18 in the DB server 152 acquires an unused call number from the call information 104 (Step S104). The call number management unit 18 allocates the acquired call number to the call in which the setting request is received from the outgoing side system 30. Furthermore, the call number management unit 18 registers information in each of the items associated with the allocated call number in the server management information 103 (Step S105). Furthermore, the call number management unit 18 sends the allocated call number to the call control server 20 (Step S106).

The call processing unit 202 in the call control server 20 receives, from the call number management unit 18 in the DB server 152, the call number that has been allocated to the call in which the setting request is received from the outgoing side system 30. Then, the call processing unit 202 creates call information that is associated with the call number that is allocated by using the setting request received from the outgoing side system (Step S107). Then, the call processing unit 202 sends the created call information to the DB server 152 (Step S108).

The call information access control unit 17 in the DB server 152 receives the call information from the call processing unit 202 in the call control server 20. Then, the call information access control unit 17 registers the received call information in the call information 104 (Step S109).

The call processing unit 202 in the call control server 20 creates a signal that is used to send INVITE to the incoming side system 40 (Step S110). At this point, the call processing unit 202 edits the Via header and the Record-Route header of the created signal such that the signal is to be sent via the assignment server 151. Then, the call processing unit 202 sends INVITE to the incoming side system 40 by using the created signal (Step S111).

When the incoming side system 40 receives INVITE, the incoming side system 40 checks each of the headers in the received signal and specifies the response destination of the received signal. Then, the incoming side system 40 sends, to the assignment server 151, 100 Trying that is a response indicating that INVITE has been received (Step S112).

The assignment control unit 12 in the assignment server 151 receives the 100 Trying from the incoming side system 40. Then, the assignment control unit 12 sends the 100 Trying to the call control server 20 (Step S113).

The call processing unit 202 in the call control server 20 receives the 100 Trying from the assignment control unit 12 in the assignment server 151. Then, the call processing unit 202 sends a call information read request to the DB server 152 (Step S114).

The call information access control unit 17 in the DB server 152 receives the call information read request from the call processing unit 202 in the call control server 20. Then, the call information access control unit 17 reads, from the call information 104, the call information that is related to the call that is associated with the call information read request (Step S115). Then, the call information access control unit 17 sends the read call information to the call control server (Step S116).

The call processing unit 202 in the call control server 20 receives the call information from the call information access control unit 17 in the DB server 152. Then, the call processing unit 202 shifts the information that indicates the state of the call included in the call information to information that indicates the state in which the 100 Trying was acquired (Step S117). Then, the call processing unit 202 sends the call information write request to the DB server 152 together with the changed call information (Step S118).

The call information access control unit 17 in the DB server 152 receives, in addition to the call information in which the call state has been changed, the call information write request from the call processing unit 202 in the call control server 20. Then, the call information access control unit 17 writes the call information, in which the call state has been changed into the state in which the 100 Trying is received, into the call information 104 and updates the call information 104 (Step S119).

The call processing unit 202 in the call control server 20 creates a signal that is used to send the 100 Trying to the outgoing side system 30 (Step S120). Then, the call processing unit 202 sends the 100 Trying to the outgoing side system 30 by using the created signal (Step S121).

The incoming side system 40 sends, to the assignment server 151, 180 Ringing that is a response indicating that the incoming side device has received INVITE and is calling by ringing a bell or the like (Step S122).

The assignment control unit 12 in the assignment server 151 receives 180 Ringing from the incoming side system 40. Then, the assignment control unit 12 sends 180 Ringing to the call control server 20 (Step S123).

The call processing unit 202 in the call control server 20 receives 180 Ringing from the assignment control unit 12 in the assignment server 151. Then, the call processing unit 202 sends the call information read request to the DB server 152 (Step S124).

The call information access control unit 17 in the DB server 152 receives the call information read request from the call processing unit 202 in the call control server 20. Then, the call information access control unit 17 reads, from the call information 104, the call information on the call associated with the call information read request (Step S125). Then, the call information access control unit 17 sends the read call information to the call control server 20 (Step S126).

The call processing unit 202 in the call control server 20 receives the call information from the call information access control unit 17 in the DB server 152. Then, the call processing unit 202 shifts the information that indicates the state of the call included in the call information to information that indicates the state in which a call is being performed (Step S127). Then, the call processing unit 202 sends the call information write request to the DB server 152 together with the changed call information (Step S128).

The call information access control unit 17 in the DB server 152 receives call information write request from the call processing unit 202 in the call control server 20 together with the call information in which the call state has been changed. Then, the call information access control unit 17 writes the call information in which the call state is changed to the calling state into the call information 104 and updates the call information 104 (Step S129).

The call processing unit 202 in the call control server 20 creates a signal that is used to send 180 Ringing to the outgoing side system 30 (Step S130). Then, the call processing unit 202 sends 180 Ringing to the outgoing side system 30 by using the created signal (Step S131).

Then, if a response to the call is received by the incoming side device, the incoming side system 40 sends, to the assignment server 151, 200 OK that indicates that the request for INVITE has been processed normally, i.e., that indicates the call has been successful (Step S132).

The assignment control unit 12 in the assignment server 151 receives 200 OK from the incoming side system 40. Then, the assignment control unit 12 sends 200 OK to the call control server 20 (Step S133).

The call processing unit 202 in the call control server 20 receives 200 OK from the assignment control unit 12 in the assignment server 151. Then, the call processing unit 202 sends the call information read request to the DB server 152 (Step S134).

The call information access control unit 17 in the DB server 152 receives the call information read request from the call processing unit 202 in the call control server 20. Then, the call information access control unit 17 reads, from the call information 104, call information on the call associated with the call information read request (Step S135). Then, the call information access control unit 17 sends the read call information to the call control server 20 (Step S136).

The call processing unit 202 in the call control server 20 receives the call information from the call information access control unit 17 in the DB server 152. Then, the call processing unit 202 shifts the information that indicates the state of the call included in the call information to information that indicates the state in which the call has been successful (Step S137). Then, the call processing unit 202 sends the call information write request together with the changed call information to the DB server 152 (Step S138).

The call information access control unit 17 in the DB server 152 receives the call information write request from the call processing unit 202 in the call control server 20 together with the call information in which the call state has been changed. Then, the call information access control unit 17 writes the call information, in which the call state has been changed into the state in which the call has been successful, into the call information 104 and then updates the call information 104 (Step S139).

The call processing unit 202 in the call control server 20 creates a signal that is used to send 200 OK to the outgoing side system 30 (Step S140). Then, the call processing unit 202 sends 200 OK to the outgoing side system 30 by using the created signal (Step S141).

The outgoing side system 30 receives 200 OK from the call processing unit 202 in the call control server 20. Then, the outgoing side system 30 sends, to the call control server 20, ACT that is an acknowledgment response indicating that the response, i.e., 200 OK, has been received (Step S142).

The call processing unit 202 in the call control server 20 receives 200 OK from the outgoing side system 30. Then, the call processing unit 202 sends the call information read request to the DB server 152 (Step S143).

The call information access control unit 17 in the DB server 152 receives the call information read request from the call processing unit 202 in the call control server 20. Then, the call information access control unit 17 reads, from the call information 104, the call information on the call associated with the call information read request (Step S144). Then, the call information access control unit 17 sends the read call information to the call control server 20 (Step S145).

The call processing unit 202 in the call control server 20 receives the call information from the call information access control unit 17 in the DB server 152. Then, the call processing unit 202 shifts the information that indicates the state of the call included in the call information to information that indicates the state in which a communication call is being performed (Step S146). Then, the call processing unit 202 sends a call information write request to the DB server 152 together with the changed call information (Step S147).

The call information access control unit 17 in the DB server 152 receives the call information write request from the call processing unit 202 in the call control server 20 together with the call information in which the call state has been changed. Then, the call information access control unit 17 writes the call information, in which the call state has been changed to the state in which a communication call is being performed, into the call information 104 and updates the call information 104 (Step S148).

The call processing unit 202 in the call control server 20 creates a signal that is used to send ACT to the incoming side system 40 (Step S149). Then, the call processing unit 202 sends ACT to the incoming side system 40 by using the created signal (Step S150). Consequently, communication has been established and a communication call is performed between the outgoing side device in the outgoing side system 30 and the incoming side device in the incoming side system 40 (Step S151).

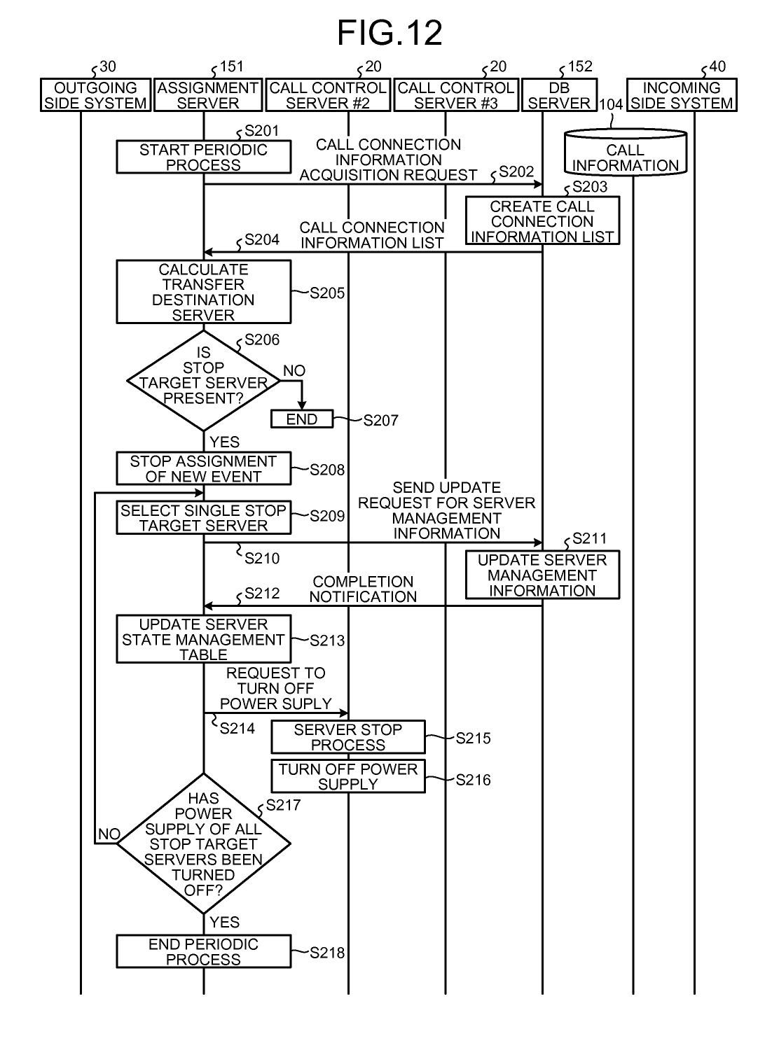

In the following, the flow of a transfer process on a call process will be described with reference to FIG. 12 by using the communication information system illustrated in FIG. 10. FIG. 12 is a sequence diagram illustrating a transfer process of transferring a call process. Here, a description will be given below in a case in which the call process managed by the call control server #2 is transferred to the call control server #3.

The server stop control unit 15 in the assignment server 151 starts a periodic process in which a call process is transferred (Step S201). The server stop control unit 15 sends a call connection information acquisition request to the DB server 152 (Step S202). At this point, the server stop control unit 15 sends the server management information 103 to the DB server 152.

The call connection count management unit 16 in the DB server 152 receives the call connection information acquisition request from the server stop control unit 15 in the assignment server 151. Then, the call connection count management unit 16 creates the call connection information list 102 from the server management information 103 (Step S203). Then, the call connection count management unit 16 sends the created call connection information list 102 to the assignment server 151 (Step S204).

The server stop control unit 15 in the assignment server 151 receives the call connection information list 102 from the call connection count management unit 16 in the DB server 152. Then, the server stop control unit 15 performs calculation to determine a server at the transfer destination by, for example, sorting the call control servers 20 in ascending order of the call connection counts (Step S205). The server stop control unit 15 determines, from the calculation result related to the transfer destination servers, whether a stop target server is present (Step S206). If no stop target server is present (No at Step S206), the server stop control unit 15 ends the transfer process on the call process (Step S207).

In contrast, if a stop target server is present (Yes at Step S206), the server stop control unit 15 notifies the assignment control unit 12 that the assignment of a new event to the call control server #2 is to be stopped. The assignment control unit 12 stops the assignment of the new event to the call control server #2 (Step S208).

The server stop control unit 15 selects a single server from among the stop target servers (Step S209). Then, the server stop control unit 15 sends, to the DB server 152, an update request for the information on the selected stop target server in the server management information 103 (Step S210). At this point, the server stop control unit 15 sends, to the DB server 152, the information on the selected stop target server and the information on the transfer destination server to which the call process that is managed by the stop target server is to be transferred.

The transfer destination server management unit 14 in the DB server 152 receives the update request for the server management information 103 from the server stop control unit 15 in the assignment server 151. Then, the transfer destination server management unit 14 updates both the operation state of the specified stop target server and the server number at the transfer destination (Step S211). Then, the transfer destination server management unit 14 notifies the assignment server 151 of a completion notification indicating that the update of the server management information 103 has been completed (Step S212).

The server stop control unit 15 in the assignment server 151 receives the completion notification indicating that the update of the server management information 103 has been completed from the transfer destination server management unit 14 in the DB server 152. Then, the server stop control unit 15 sends, to the assignment control unit 12, an instruction to update the server state management table 101 together with the selected server that can be stopped and the information on the transfer destination server to which the call process that was managed by the server that can be stopped is transferred. The assignment control unit 12 updates the operation state of the specified stop target server and the transfer destination server address in the server state management table 101 (Step S213).

The server stop control unit 15 sends a power supply OFF request to the call control server #2 that is the stop target server (here, a description will be given of the call control server #2 as an example) (Step S214).

The power supply control unit 203 in the call control server #2 receives the power supply OFF request from the server stop control unit 15 in the assignment server 151. Then, the power supply control unit 203 performs a stop process on a server (Step S215). After the completion of the stop process on the server, the power supply control unit 203 turns off the power supply of the call control server #2 (Step S216).

The server stop control unit 15 determines whether the power supply of all of the stop target servers is turned off (Step S217). If a stop target server in which the power supply is not turned off is present (No at Step S217), the server stop control unit 15 returns to Step S209.

In contrast, if the power supply of all of the stop target servers is turned off (Yes at Step S217), the server stop control unit 15 ends the periodic process (Step S218).

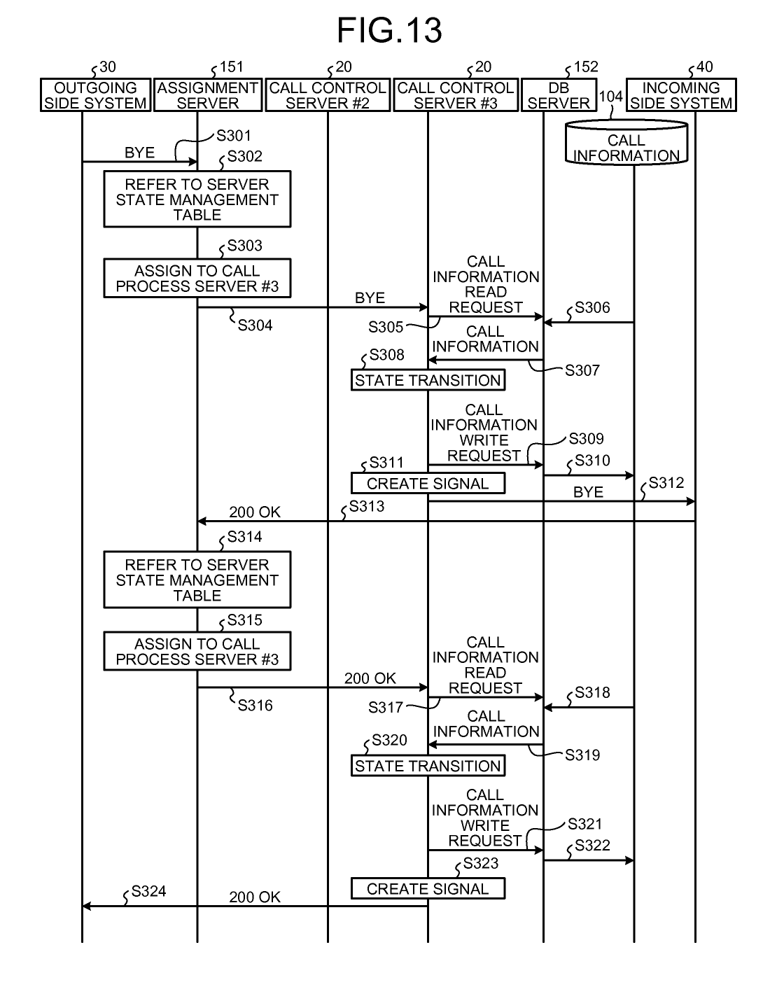

In the following, the flow of the call process after the transfer will be described with reference to FIG. 13 by using the communication information system illustrated in FIG. 10 as an example. FIG. 13 is a sequence diagram illustrating a call process after the transfer. Here, a description will be given below in a case in which the call process managed by the call control server #2 is transferred to the call control server #3.

The outgoing side system 30 sends BYE that is a call end request with respect to the call created by the call control server #2 to the assignment server 151 (Step S301).

The assignment control unit 12 in the assignment server 151 receives BYE from the outgoing side system 30. The assignment control unit 12 refers to the server state management table 101 (Step S302). The assignment control unit 12 acquires, from the server state management table 101, the call control server 20 that manages the call process in which the call number of the call requested by the call end request. In this example, because the call process for the call created by the call control server #2 is managed by the call control server #3, the assignment control unit 12 acquires the call control server #3 as the assignment destination of BYE. Then, the assignment control unit 12 assigns BYE to the call control server #3 (Step S303). The assignment control unit 12 sends BYE to the call control server #3 (Step S304).

The call processing unit 202 in the call control server #3 receives BYE from the assignment control unit 12 in the assignment server 151. Then, the call processing unit 202 send a call information read request to the DB server 152 (Step S305).

The call information access control unit 17 in the DB server 152 receives the call information read request from the call processing unit 202 in the call control server #3. Then, the call information access control unit 17 read, from the call information 104, the call information on the call that is associated with the call information read request (Step S306). Then, the call information access control unit 17 sends the read call information to the call control server #3 (Step S307).

The call processing unit 202 in the call control server #3 receives the call information from the call information access control unit 17 in the DB server 152. Then, the call processing unit 202 shifts the information that indicates the state of the call included in the call information to information that indicates the state in which a communication call has been ended (Step S308). Then, the call processing unit 202 sends a call information write request to the DB server 152 together with the changed call information (Step S309).

The call information access control unit 17 in the DB server 152 receives the call information write request from the call processing unit 202 in the call control server 20 together with the call information in which the call state has been changed. Then, the call information access control unit 17 writes the call information in which the call state has been changed to the end of the communication call into the call information 104 and updates the call information 104 (Step S310).

The call processing unit 202 in the call control server #3 creates a signal that is used to send BYE to the incoming side system 40 (Step S311). Then, the call processing unit 202 sends BYE to the incoming side system 40 by using the created signal (Step S312).

The incoming side system 40 receives BYE from the call processing unit 202 in the call control server #3. Then, the incoming side system 40 sends 200 OK that is the signal representing that disconnection has been successful to the assignment server 151 (Step S313).

The assignment control unit 12 in the assignment server 151 receives 200 OK from the incoming side system 40. The assignment control unit 12 refers to the server state management table 101 (Step S314). Then, the assignment control unit 12 acquires, from the server state management table 101, the call control server 20 that manages the call process to which the call number of the call in which the call has been ended is allocated. In this example, because the call control server #3 manages the call process performed by the call that has been created by the call control server #2, the assignment control unit 12 acquires the call control server #3 as the assignment destination of 200 OK. Then, the assignment control unit 12 assigns 200 OK to the call control server #3 (Step S315). Then, the assignment control unit 12 sends 200 OK to the call control server #3 (Step S316).

The call processing unit 202 in the call control server #3 receives 200 OK from the assignment control unit 12 in the assignment server 151. Then, the call processing unit 202 sends a call information read request to the DB server 152 (Step S317).

The call information access control unit 17 in the DB server 152 receives the call information read request from the call processing unit 202 in the call control server #3. Then, the call information access control unit 17 read, from the call information 104, the call information on the call that is associated with the call information read request (Step S318). Then, the call information access control unit 17 sends the read call information to the call control server 20 (Step S319).

The call processing unit 202 in the call control server #3 receives the call information from the call information access control unit 17 in the DB server 152. Then, the call processing unit 202 shifts the information that indicates the state of the call included in the call information to information that indicates the state in which the communication call has been ended (Step S320). Then, the call processing unit 202 sends a call information write request to the DB server 152 together with the changed call information (Step S321).

The call information access control unit 17 in the DB server 152 receives the call information write request from the call processing unit 202 in the call control server 20 together with the call information in which the call state has been changed. Then, the call information access control unit 17 writes the call information in which the call state has been changed to the end of the communication call into the call information 104 and updates the call information 104 (Step S322).

The call processing unit 202 in the call control server #3 creates a signal that is used to send 200 OK to the outgoing side system 30 (Step S323). Then, the call processing unit 202 sends 200 OK to the outgoing side system 30 by using the created signal and notifies the outgoing side system 30 that disconnection has been successful (Step S324).

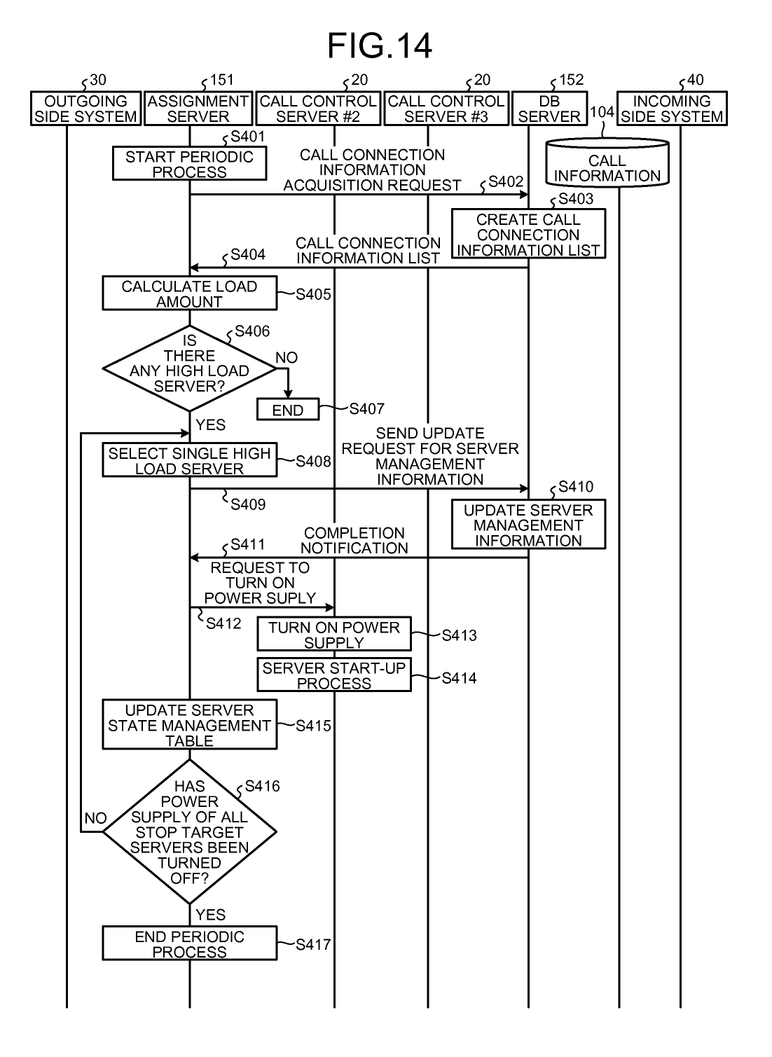

In the following, the flow of a return process of returning a call process will be described with reference to FIG. 14 by using the communication information system illustrated in FIG. 10 as an example. FIG. 14 is a sequence diagram illustrating a return process of returning a call process. Here, a description will be given below in a case in which the call process transferred to the call control server #3 is returned to the call control server #2.

The server start-up control unit 11 in the assignment server 151 starts a periodic process in which a call process is transferred (Step S401). The server start-up control unit 11 sends a call connection information acquisition request to the DB server 152 (Step S402). At this point, the server start-up control unit 11 sends the server management information 103 to the DB server 152.

The call connection count management unit 16 in the DB server 152 receives the call connection information acquisition request from the server start-up control unit 11 in the assignment server 151. Then, the call connection count management unit 16 creates the call connection information list 102 from the server management information 103 (Step S403). Then, the call connection count management unit 16 sends the created call connection information list 102 to the assignment server 151 (Step S404).

The server start-up control unit 11 in the assignment server 151 receives the call connection information list 102 from the call connection count management unit 16 in the DB server 152. If the call control server 20 that is being stopped is present, the server start-up control unit 11 calculates the amount of the load applied to the call control server 20 that is running (Step S405). The server start-up control unit 11 determines, from the result of calculation about the amount of the load, whether a high load server is present (Step S406). If no high load server is present (No at Step S406), the server start-up control unit 11 ends the return process performed on the call process (Step S407).

In contrast, if high load servers are present (Yes at Step S406), the server start-up control unit 11 selects a single server from among the high load servers (Step S408). Then, the server start-up control unit 11 sends, to the DB server 152, an update request for the information, which is stored in the server management information 103, on the selected high load server and on the transfer source server to which the call process managed by the high load server is to be returned (Step S409). At this point, the server start-up control unit 11 sends, to the DB server 152, the information on the transfer source server to which the call process managed by the high load server is to be returned.

The transfer destination server management unit 14 in the DB server 152 receives the update request for the server management information 103 from the server start-up control unit 11 in the assignment server 151. Then, the transfer destination server management unit 14 returns the operation state of the transfer source server to which the specified call process is returned to “normal” and changes the number that indicates the transfer destination server to “NULL”, thereby updating the server management information 103 (Step S410). Then, the transfer destination server management unit 14 notifies the assignment server 151 of a completion notification that the update of the server management information 103 has been completed (Step S411).

The server start-up control unit 11 in the assignment server 151 receives the completion notification of the update of the server management information 103 from the transfer destination server management unit 14 in the DB server 152. Then, the server start-up control unit 11 sends a power supply ON request to the call control server #2 to which the call process is to be returned (here, a description will be given of the call control server #2 as an example) (Step S412).

The power supply control unit 203 in the call control server #2 receives the power supply ON request from the server start-up control unit 11 in the assignment server 151. Then, the power supply control unit 203 turns on the power supply of the server (Step S413). Then, the power supply control unit 203 preforms a server start-up process (Step S414).

The server start-up control unit 11 in the assignment server 151 sends, to the assignment control unit 12, an instruction to update the server state management table 101 together with the information on the selected high load server and information on the transfer source server to which the call process managed by the high load server is to be returned. The assignment control unit 12 returns the operation state on the transfer source server, to which the call process managed by the high load server that is specified in the server state management table 101 is to be returned, to “normal” and returns the transfer destination server address to “NULL”, thereby updating the server state management table 101 (Step S415).

The server start-up control unit 11 in the assignment server 151 determines whether the power supply of all of the stop target servers has been turned on (Step S416). If the power supply of some of the stop target servers has not been turned on (No at Step S416), the server stop control unit 15 returns to Step S408.

In contrast, if the power supply of all of the stop target servers has been turned on (Yes at Step S416), the server start-up control unit 11 ends the periodic process (Step S417).

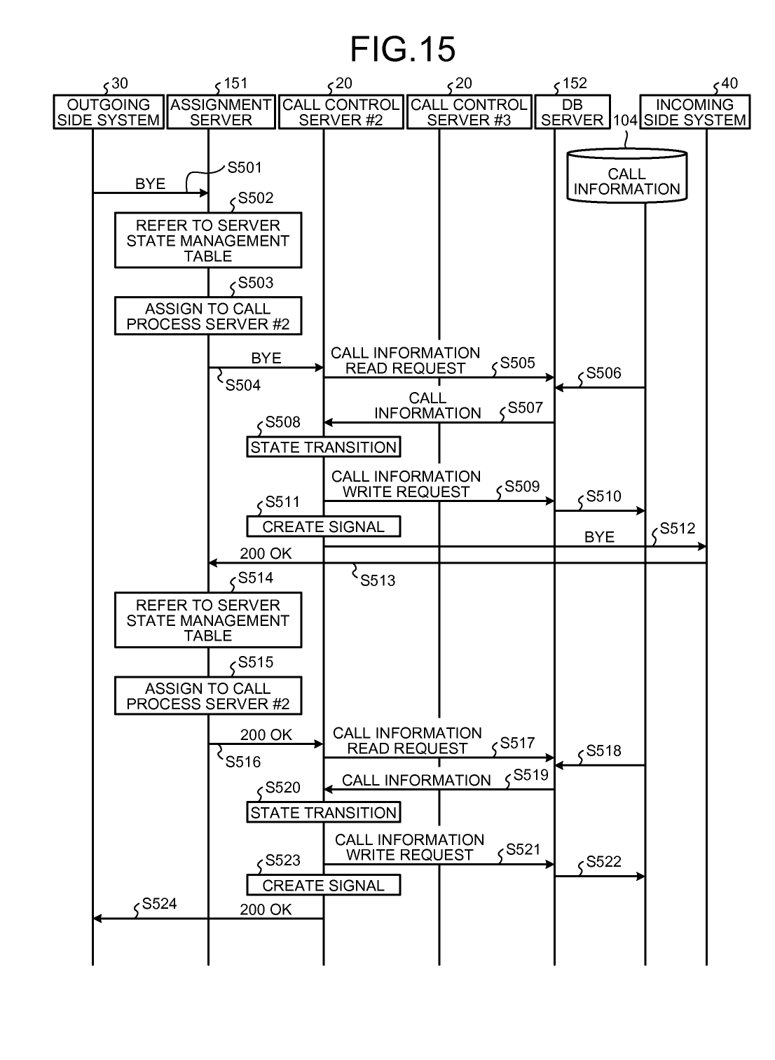

In the following, the flow of a call process after the process has been returned will be described with reference to FIG. 15 by using the communication information system illustrated in FIG. 10 as an example. FIG. 15 is a sequence diagram illustrating a call process after the call process has been returned. Here, a description will be given below in a case in which the call process transferred to the call control server #3 is returned to the call control server #2.

The outgoing side system 30 sends BYE that is a call end request with respect to the call created by the call control server #2 to the assignment server 151 (Step S501).

The assignment control unit 12 in the assignment server 151 receives BYE from the outgoing side system 30. The assignment control unit 12 refers to the server state management table 101 (Step S502). The assignment control unit 12 acquires, from the server state management table 101, the call control server 20 that manages the call process to which the call number of the call requested by a call end request is allocated. In this example, because the call process managed by the call control server #3 has been returned to the call control server #2, the assignment control unit 12 acquires the call control server #2 as the assignment destination of BYE. Then, the assignment control unit 12 assigns BYE to the call control server #2 (Step S503). The assignment control unit 12 sends BYE to the call control server #2 (Step S504).

The call processing unit 202 in the call control server #2 receives BYE from the assignment control unit 12 in the assignment server 151. Then, the call processing unit 202 sends a call information read request to the DB server 152 (Step S505).

The call information access control unit 17 in the DB server 152 receives the call information read request from the call processing unit 202 in the call control server #2. Then, the call information access control unit 17 reads, from the call information 104, the call information on the call associated with the call information read request from the call information 104 (Step S506). Then, the call information access control unit 17 sends the read call information to the call control server #2 (Step S507).

The call processing unit 202 in the call control server #2 receives the call information from the call information access control unit 17 in the DB server 152. Then, the call processing unit 202 shifts the information that indicates the state of the call included in the call information to information that indicates the state in which the call has been ended (Step S508). Then, the call processing unit 202 sends a call information write request to the DB server 152 together with the changed call information (Step S509).

The call information access control unit 17 in the DB server 152 receives the call information write request from the call processing unit 202 in the call control server 20 together with the call information in which the call state has been changed. Then, the call information access control unit 17 writes the call information, in which the call state has been changed to the state in which the call has been ended, into the call information 104, thereby updating the call information 104 (Step S510).

The call processing unit 202 in the call control server #2 creates a signal that is used to send BYE to the incoming side system 40 (Step S511). Then, the call processing unit 202 sends BYE by using the created signal to the incoming side system 40 (Step S512).

The incoming side system 40 receives BYE from the call processing unit 202 in the call control server #2. Then, the incoming side system 40 sends, to the assignment server 151, 200 OK that is the signal representing that disconnection has been successful (Step S513).

The assignment control unit 12 in the assignment server 151 receives 200 OK from the incoming side system 40. The assignment control unit 12 refers to the server state management table 101 (Step S514). Then, the assignment control unit 12 acquires, from the server state management table 101, the call control server 20 that manages the call process to which the call number of the call that has been ended is allocated. Here, because the call process that was managed by the call control server #3 is returned to the call control server #2, the assignment control unit 12 acquires the call control server #2 as the assignment destination of 200 OK. Then, the assignment control unit 12 assigns 200 OK to the call control server #2 (Step S515). Then, the assignment control unit 12 sends 200 OK to the call control server #2 (Step S516).

The call processing unit 202 in the call control server #2 receives 200 OK from the assignment control unit 12 in the assignment server 151. Then, the call processing unit 202 sends a call information read request to the DB server 152 (Step S517).

The call information access control unit 17 in the DB server 152 receives the call information read request from the call processing unit 202 in the call control server #2. Then, the call information access control unit 17 reads, from the call information 104, the call information on the call associated with the call information read request (Step S518). Then, the call information access control unit 17 sends the read call information to the call control server #2 (Step S519).

The call processing unit 202 in the call control server #2 receives the call information from the call information access control unit 17 in the DB server 152. Then, the call processing unit 202 shifts the information that indicates the state of the call included in the call information to information that indicates the state in which the communication call has been ended (Step S520). Then, the call processing unit 202 sends a call information write request to the DB server 152 together with the changed call information (Step S521).

The call information access control unit 17 in the DB server 152 receives the call information write request from the call processing unit 202 in the call control server 20 together with the call information in which the call state has been changed. Then, call information access control unit 17 writes the call information in which the call state has been changed to the state in which the communication call has been ended, into the call information 104, thereby updating the call information 104 (Step S522).

The call processing unit 202 in the call control server 20 creates a signal that is used to send 200 OK to the outgoing side system 30 (Step S523). Then, the call processing unit 202 sends 200 OK to the outgoing side system 30 by using the created signal and notifies that disconnection has been successful (Step S524).

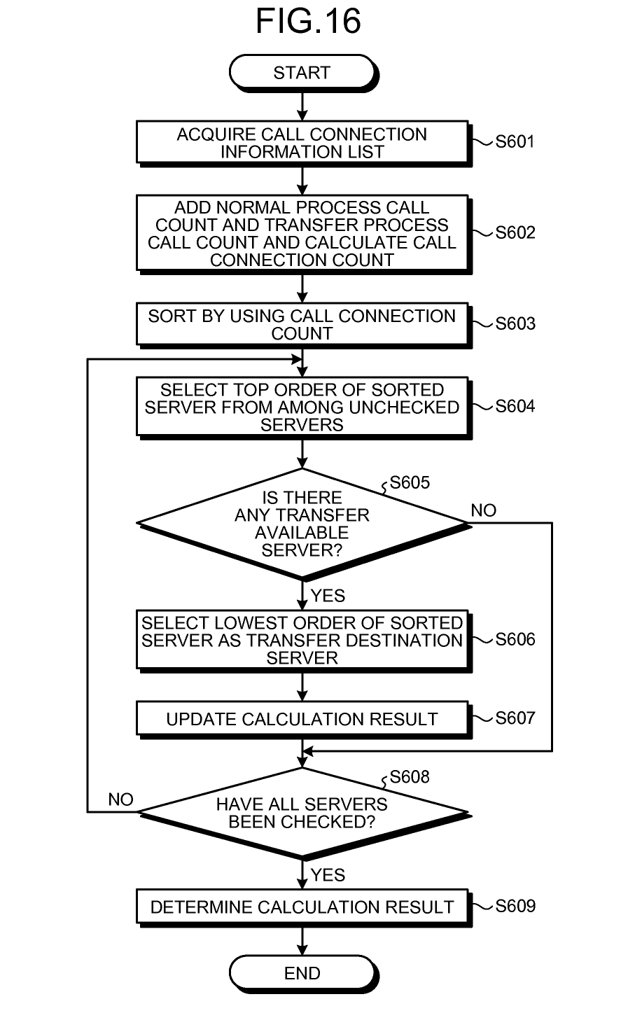

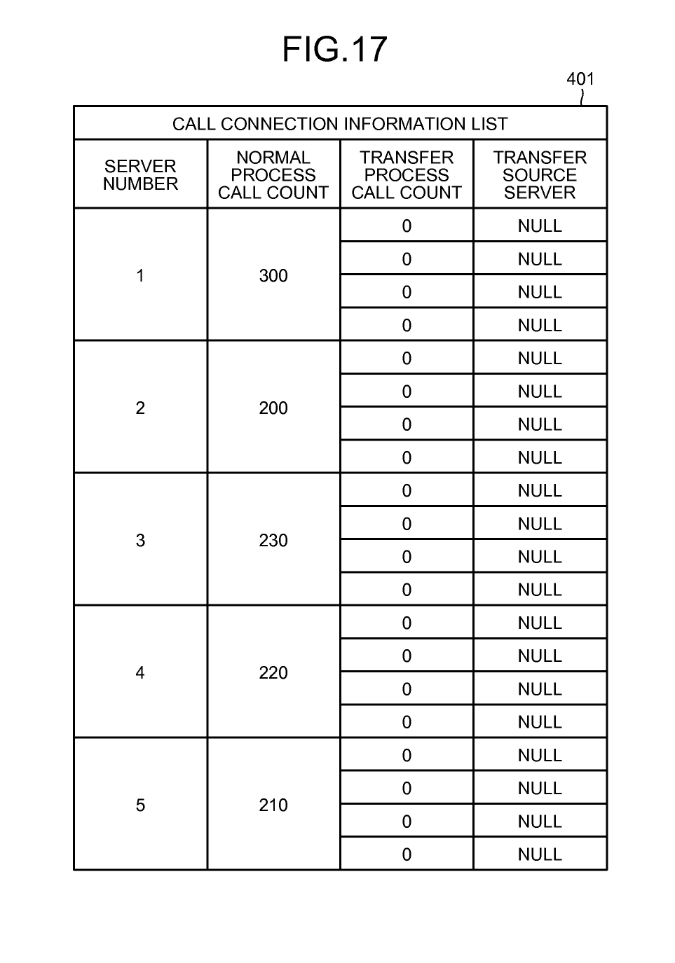

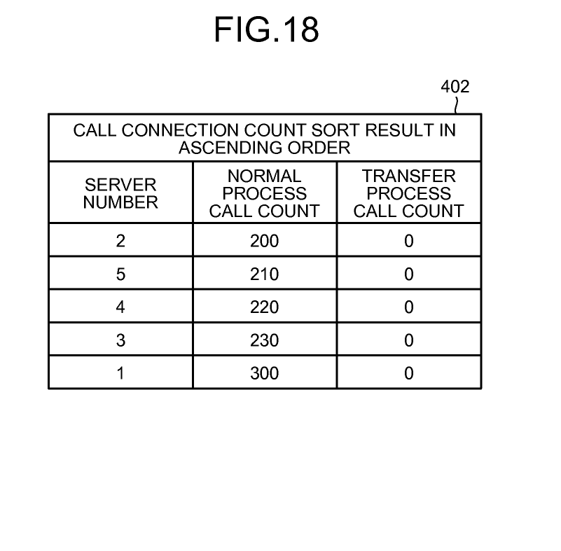

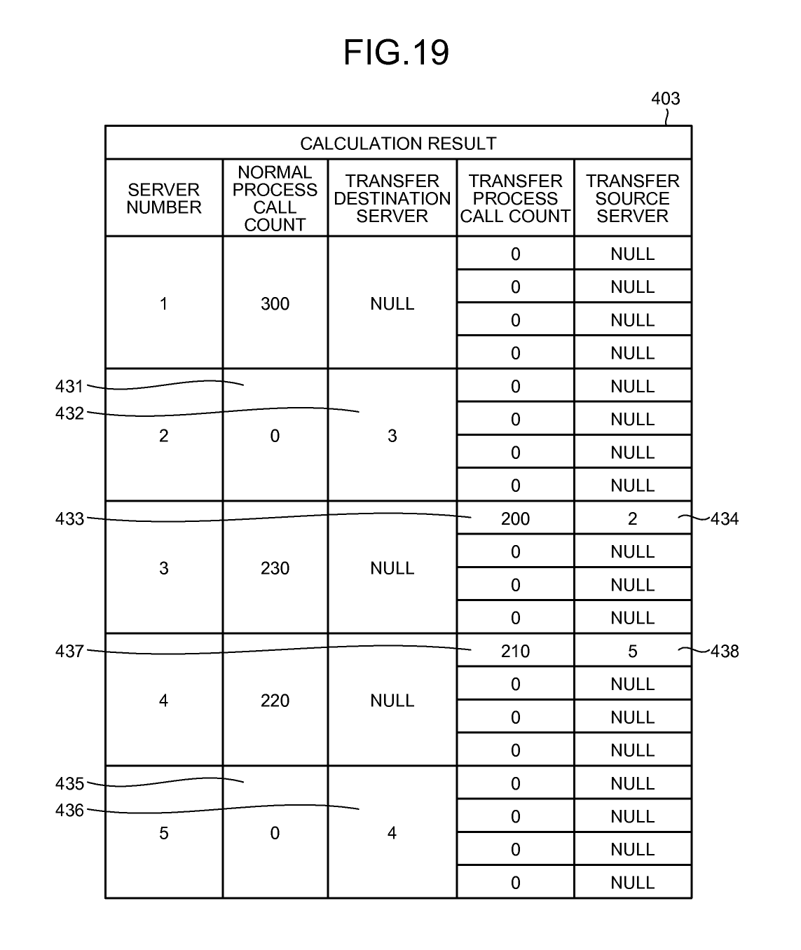

In the following, the flow of a determination process that determines a stop target server and a transfer destination server and a change in various kinds of information will be described with reference to FIGS. 16 to 19. FIG. 16 is a flowchart illustrating the flow of a determination process that determines a stop target server and a transfer destination server. FIG. 17 is a schematic diagram illustrating an example of the state of the call connection information list before the transfer. FIG. 18 is a schematic diagram illustrating an example of a call connection counts sort result in ascending order. FIG. 19 is a schematic diagram illustrating an example of the calculation result obtained when the determination process that determines the stop target server and the transfer destination server is performed. In this example, a description will be given of a case in which a transfer of a call process has not been performed in any one of the call control servers 20. Here, a description will be given of a case, as an example, in which the call control servers 20 with the server numbers of 1 to 5 are used. In a description below, the call control servers 20 with the server numbers 1 to 5 are represented by call control servers #1 to #5, respectively.

When the server stop control unit 15 starts the determination process on the stop target server, the server stop control unit 15 notifies the call connection count management unit 16 of an acquisition request for the call connection information list 102 and acquires the call connection information list 102 from the call connection count management unit 16 (Step S601). At this point, because a transfer of the call process has not been performed, the server stop control unit 15 acquires the call connection information list 102 illustrated by a table 401 in FIG. 17. In the table 401, the transfer process call count is zero in all of the call control servers 20 and “NULL” is indicated in all of the transfer source servers.

Then, the server stop control unit 15 extracts, from the acquired call connection information list 102, the normal process call count and the transfer process call count of each of the call control server 20; adds, for each call control server 20, the normal process call count and the transfer process call count; and calculates a call connection count (Step S602).

Then, the server stop control unit 15 sorts the call control servers 20 in ascending order of the call connection counts (Step S603). In this case, because none of the call control servers 20 has the transferred call process, the normal process call count in the table 401 illustrated in FIG. 17 corresponds to the call connection count of each of the call control servers 20. Accordingly, if the call control servers 20 in this state are sorted in the order of call connection counts, the sort result of the call connection counts in ascending order illustrated by a table 402 in FIG. 18 is obtained. In this case, the call control servers 20 are sorted in the order of the server numbers 2, 5, 4, 3, and 1.

Then, the server stop control unit 15 selects the top server in the order of the sorted call control servers 20 that have not been checked whether the server is the stop target server (Step S604). In this example, the server stop control unit 15 selects the call control server #2 first. If the server stop control unit 15 has checked the call control server #2, the server stop control unit 15 then selects the call control server #5 and checks the call control server #5. The server stop control unit 15 repeats this process until the server stop control unit 15 checks the call control server #1.

Then, the server stop control unit 15 determines whether the amount of the load that is obtained when a call process is transferred to the selected one of the call control servers 20 falls below the server stop monitor threshold and determines whether a server to which the call process can be transferred is present in the order below the order of the currently selected call control server 20 (Step S605).

Then, from among the servers to which the call process managed by the selected call control server 20 can be transferred, the server stop control unit 15 selects the lowest order of the call control server 20 obtained from the sorting as the transfer destination server (Step S606).

Then, the server stop control unit 15 sets the call process managed by the stop target server to 0. Furthermore, the server stop control unit 15 stores the result, as the calculation result illustrated in FIG. 19, that is obtained when the call process managed by the stop target server is transferred to the transfer destination server, thereby updating the table (Step S607).

Then, the server stop control unit 15 determines whether all of the call control servers 20 have been checked (Step S608). If some of the call control servers 20 that have not been checked (No at Step S608), the server stop control unit 15 returns to Step S604. In contrast, if all of the call control servers 20 have been checked (Yes at Step S608), the server stop control unit 15 decides the calculation result (Step S609).

For example, a description will be given of a case of sorting the call control servers 20 illustrated in FIG. 18. In this case, it is assumed that the server stop monitor threshold is the amount of the load obtained when the call connection count is 500. First, the server stop control unit 15 selects the call control server #2 as the target for a check. The call connection count of the call control server #2 is 200 and the call control servers 20 that do not exceed the call connection count of 500 even if the call process managed by call control server #2 is transferred are call control servers #5, #4, and #3. Accordingly, the server stop control unit 15 determines that there is a server to which the call process managed by the call control server #2 can be transferred. Then, the server stop control unit 15 selects, from among the servers to which the call process can be transferred, the call control server #3 that is the lowest order of the sorted transfer available servers as the transfer destination server to which the call process managed by the call control server #2 is to be transferred. Then, the server stop control unit 15 sets the call process managed by the call control server #2 to zero and updates the calculation result such that the call process managed by the call control server #2 is to be transferred to the call control server #3. Specifically, in the table 401 illustrated in FIG. 19, the server stop control unit 15 sets an item 431 that indicates the normal process call count of the call control server #2 to zero. Furthermore, the server stop control unit 15 registers the server number of 3 in an item 432 that is the number indicating the transfer destination server of the call control server #2. Furthermore, the server stop control unit 15 registers the call process count of 200 managed by the call control server #2 in an item 433 that indicates the transfer process call count performed by the call control server #3. Furthermore, the server stop control unit 15 registers the server number 2 in an item 434 that indicates the transfer source server that managed the call process that has been transferred to the call control server #3.

Furthermore, a description will be given with a case of checking, after it is determined that a call process managed by the call control server #2 is transferred to the call control server #3, the call control server #5 that is the subsequent order of the servers in the table 402 illustrated in FIG. 18. In this case, the normal process call count of the call control server #5 is 210. Furthermore, because it has already been determined that the call process that was managed by the call control server #2 is to be transferred to the call control server #3, the call connection count of the call control server #3 becomes 430. Consequently, the call control server 20 that does not exceed the call connection count of 500 even if the call process managed by the call control server #5 is transferred is the call control server #4. Consequently, the server stop control unit 15 determines that there is a server to which the call process managed by the call control server #5 can be transferred and determines that the target server is the call control server #4. Then, the server stop control unit 15 sets the call process managed by the call control server #5 to zero and updates the calculation result such that the call process managed by the call control server #5 is transferred to the call control server #4. Specifically, the server stop control unit 15 sets an item 435 that indicates the normal process call count of the call control server #5 illustrated in the table 401 in FIG. 17 to zero. Furthermore, the server stop control unit 15 registers the server number 4 in an item 436 that indicates the transfer destination server number of the call control server #5. Furthermore, the server stop control unit 15 registers the call process count of 210 managed by the call control server #5 in an item 437 that indicates the transfer process call count of the call control server #4. Furthermore, the server stop control unit 15 registers the server number of 5 in an item 438 that indicates the transfer source server managed by the call process that has been transferred to the call control server #4.

Because the server that can be used for the stop target server is not present other than these described above, in this case, the server stop control unit 15 determines that the state of a table 403 illustrated in FIG. 19 is the final calculation result.

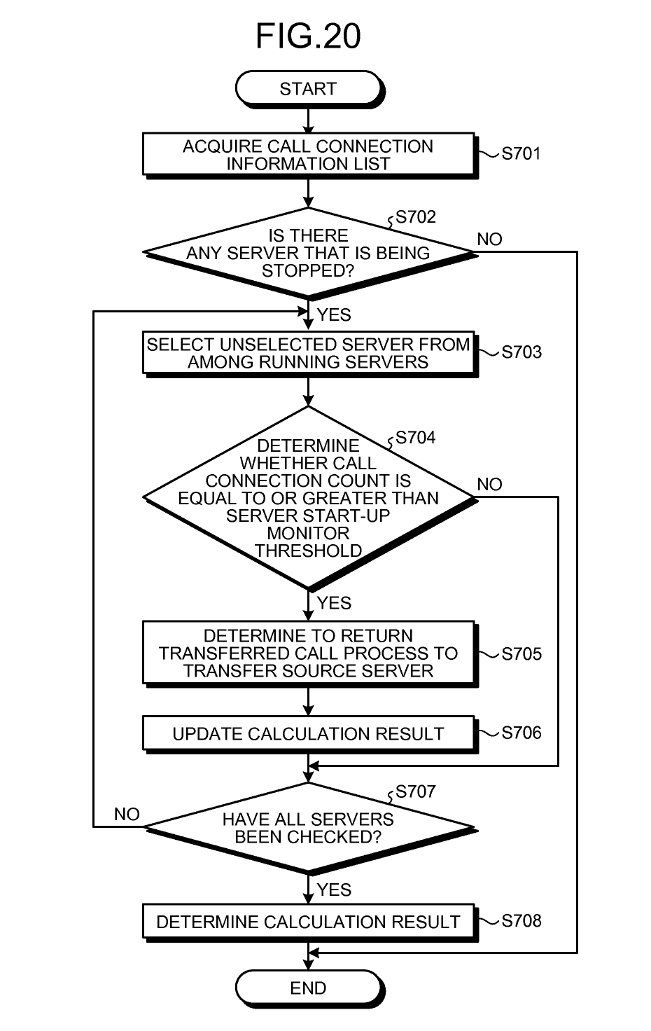

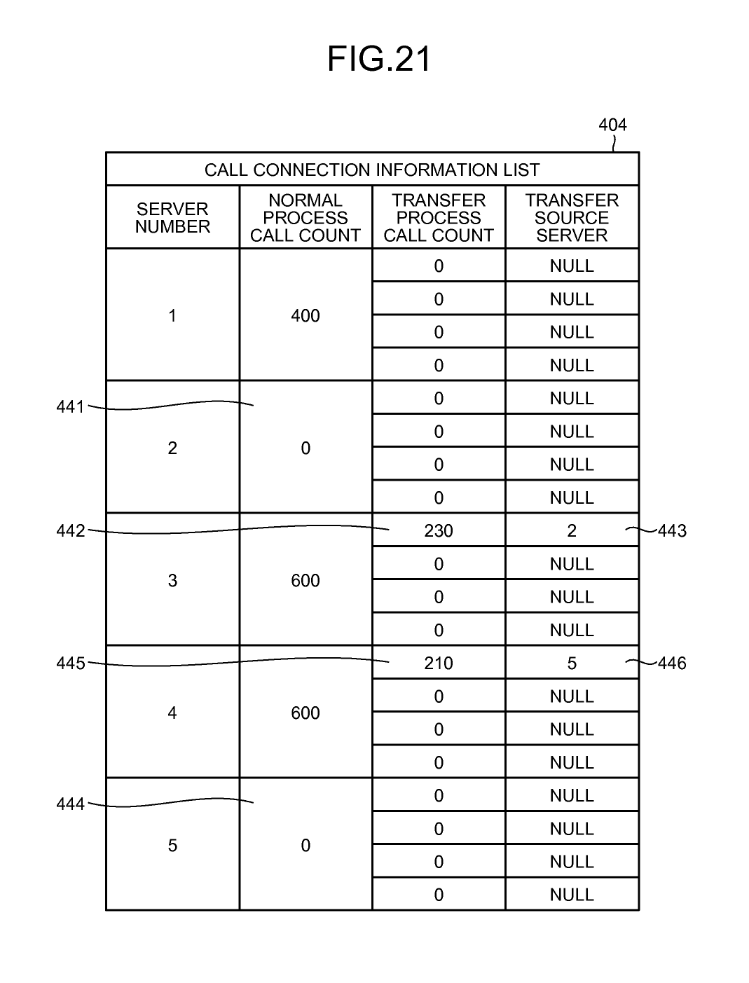

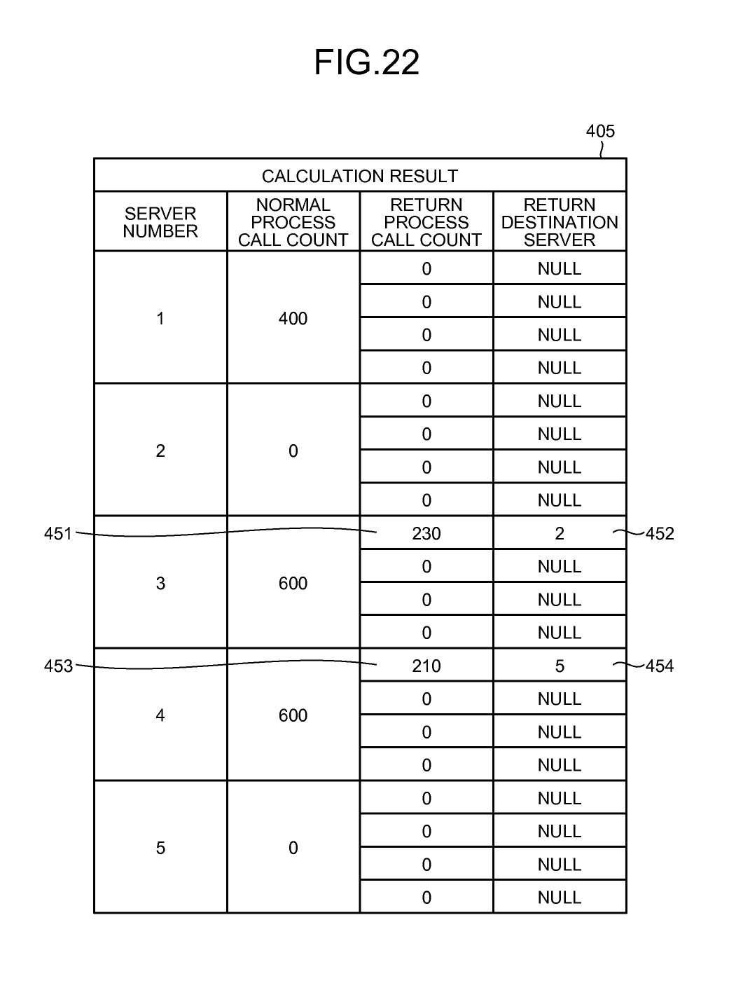

In the following, the flow of a determination process that determines the call control server 20 to which a transferred call process is to be returned and the variation of various kinds of information due to the determination process will be described with reference to FIGS. 20 to 22. FIG. 20 is a flowchart illustrating the flow of a determination process that determines a call control server to which a transferred call process is to be returned. FIG. 21 is a schematic diagram illustrating an example of the state of the call connection information list before the call process is returned. FIG. 22 is a schematic diagram illustrating an example of the calculation result obtained when the determination process that determines the call control server to which the call process is to be returned is performed. Here, a description will be given below of a case of the process that is started from the state the transfer of the call processes described with reference to FIGS. 17 to 19 have been performed.

When the server start-up control unit 11 starts the determination process that determines the call control server 20 to which a call process is to be returned, the server start-up control unit 11 notifies the call connection count management unit 16 of an acquisition request for the call connection information list 102. Then, the server start-up control unit 11 acquires the call connection information list 102 created by the call connection count management unit 16 (Step S701). In this case, the server start-up control unit 11 acquires the call connection information list 102 illustrated in FIG. 19 in which the calculation result has been updated, i.e., the call connection information list 102 illustrated by a table 404 in FIG. 21. In the table 404, an item 441 that indicates the normal process call count of the call control server #2 is zero. Furthermore, in the table 404, an item 442 that indicates the transfer process call count of the call control server #3 is 230 and the server number 2 is registered in an item 443 of the transfer source server. Furthermore, in the table 404, an item 444 that indicates the normal process call count of the call control server #5 is zero. Furthermore, in the table 404, an item 445 that indicates the transfer process call count of the call control server #4 is 210 and the server number 5 is registered in an item 446 of the transfer source server.

Then, the server start-up control unit 11 determines whether the call control server 20 that is in the stopped state is present in the call connection information list 102 (Step S702). If no stopped state server is present (No at Step S702), the server start-up control unit 11 ends the process. In contrast, if a stopped state server is present (Yes at Step S702), the server start-up control unit 11 selects the call control server 20 that has not been selected as the target for a check, from among the running call control servers 20, whether a call process is to be returned (Step S703).

Then, the server start-up control unit 11 determines whether the amount of the load applied to the selected call control server 20 is equal to or greater than the server start-up monitor threshold (Step S704). If the amount of the load applied to the selected call control server 20 is lower than the server start-up monitor threshold (No at Step S704), the server start-up control unit 11 proceeds to Step S707.

In contrast, if the amount of the load applied to the selected call control server 20 is equal to or greater than the server start-up monitor threshold (Yes at Step S704), the server start-up control unit 11 determines that the call process transferred to the selected call control server 20 is to be returned to the transfer source server (Step S705).

Then, the server start-up control unit 11 stores therein the result obtained when the call process transferred to the selected call control server 20 is returned to the transfer source server as the calculation result illustrated in FIG. 22, thereby updating the table (Step S706).

Then, the server start-up control unit 11 determines whether a check of all of the call control servers 20 has been completed (Step S707). If the call control server 20 that has not been checked is present (No at Step S707), the server start-up control unit 11 returns to Step S703. In contrast, if all of the call control servers 20 have been checked (Yes at Step S707), the server start-up control unit 11 decides the calculation result (Step S708).

For example, a description will be given of a case in which the amount of the load obtained when the call process count managed by the server start-up monitor threshold is 700. In FIG. 21, the number of connections of the call control server #3 is 830 resulting from the sum of the normal process call count and the transfer process count and the number of connections of the call control server #4 is 810. In this case, the amount of the load applied to each of the call control servers #3 and #4 exceeds the server start-up monitor threshold. Accordingly, the server start-up control unit 11 determines that the call process managed by each of the call control servers #3 and #4 is to be returned to the transfer source server. Then, the server start-up control unit 11 obtains the calculation result illustrated by a table 405 in FIG. 22. Namely, the server start-up control unit 11 registers 230 in an item 451 that indicates the return process call count for a process that returns a call process from the call control server #3 to the transfer destination server and registers the server number of 2 in an item 452 of the return destination server number that indicates the call control server 20 to which the call process is to be returned. Furthermore, the server start-up control unit 11 registers 210 in an item 453 that indicates the return process call count for a process that returns a call process from the call control server #4 to the transfer destination server and registers the server number of 5 in an item 454 of the return destination server number that indicates the call control server 20 to which the call process is to be returned.

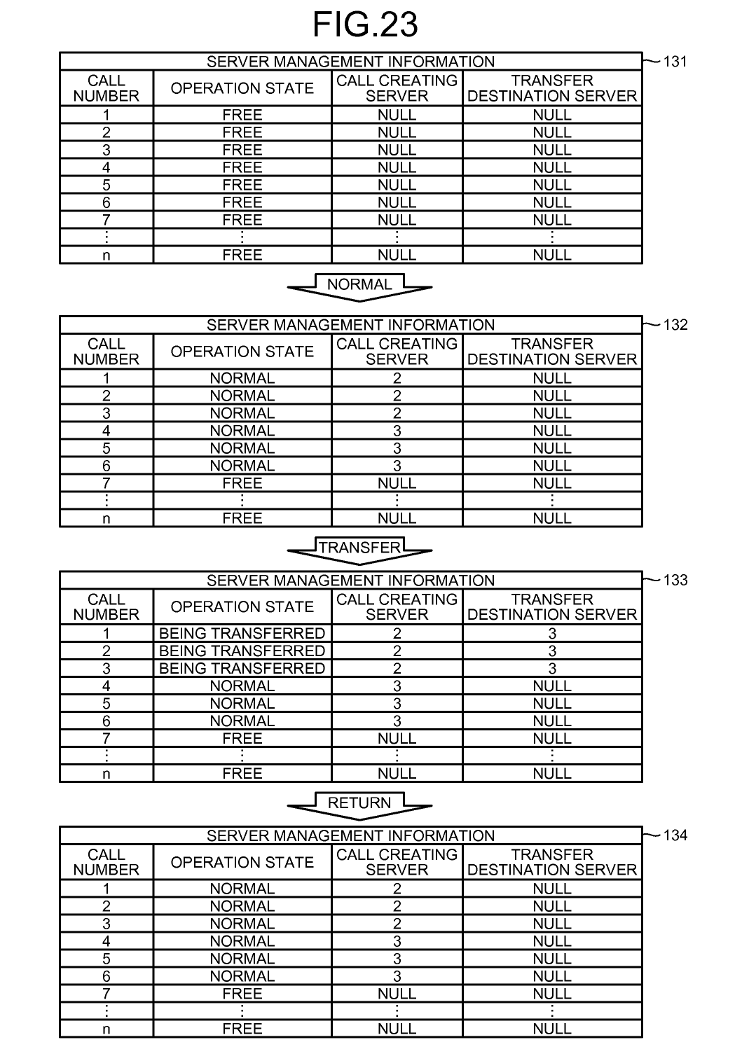

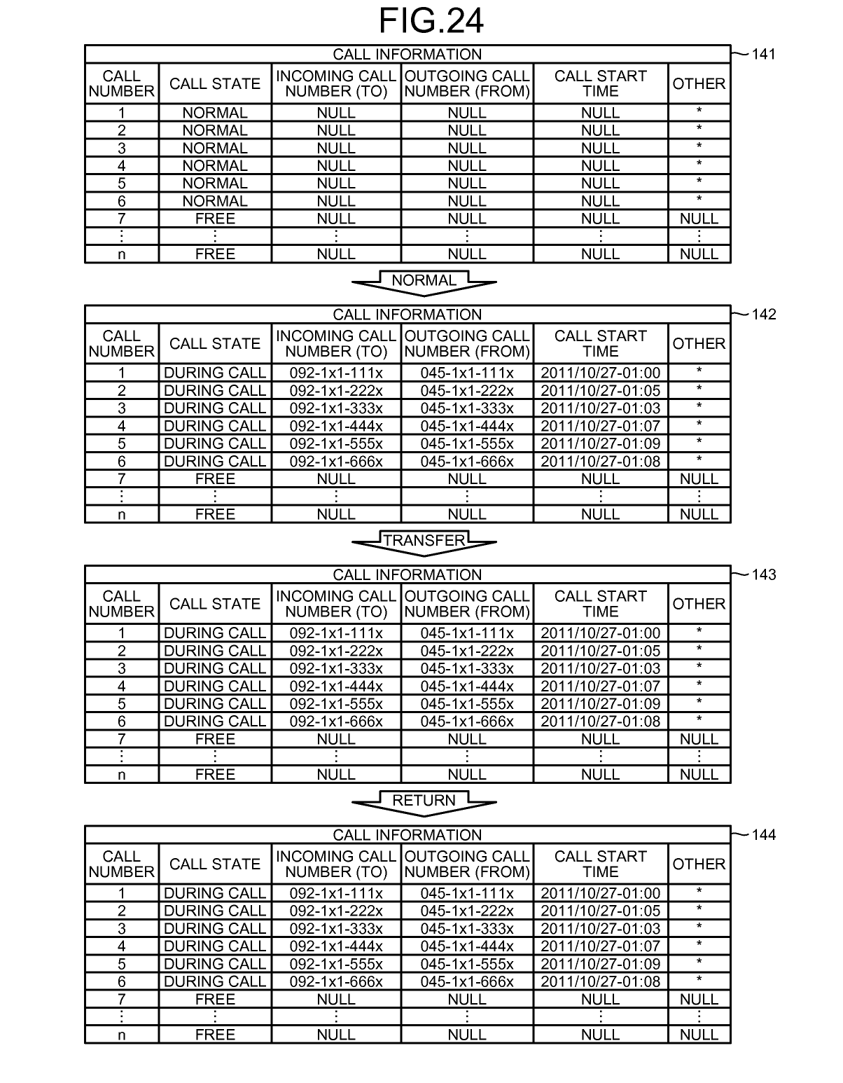

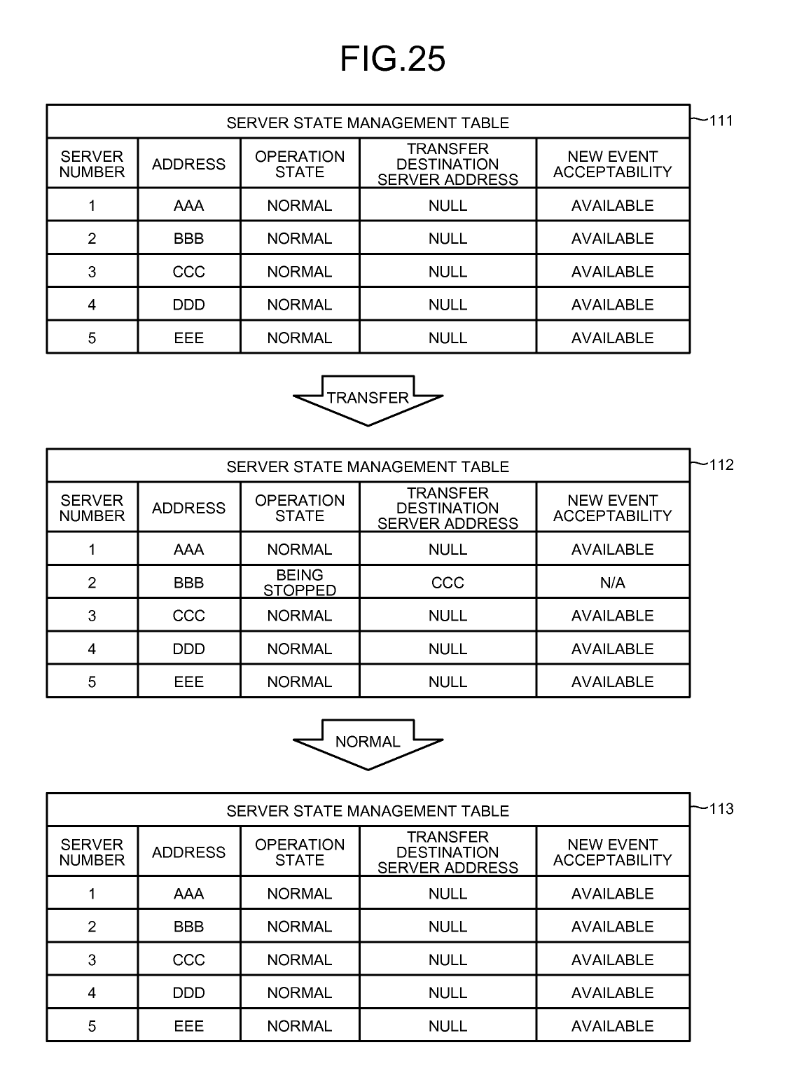

In the following, the transition of the server management information 103, the call information 104, and the server state management table 101 due to the series of the processes that return a transferred call process will be described with reference to FIGS. 23 to 25. FIG. 23 is a schematic diagram illustrating the transition of the server management information. FIG. 24 is a schematic diagram illustrating the transition of the call information. FIG. 25 is a schematic diagram illustrating the transition of the server state management table. Here, a description will be given below in a case in which the call process managed by the call control server #2 that is the call control server 20 with the server number of 2 is transferred to the call control server #3 that is the call control server 20 with the server number of 3.

If the state in which no call process is allocated to the call control servers 20, the server management information 103 indicates the state indicated by a table 131 illustrated in FIG. 23. Then, if a call process is allocated, as illustrated in a table 132, the operation state associated with each of the call numbers shifts to “normal” and the call control server that manages the associated call process is registered. In this case, because a transfer of the call process has not occurred, all of the transfer destination servers indicate “NULL”.

Then, if a call process is transferred from the call control server #2 to the call control server #3, the server management information 103 indicates the state illustrated by a table 133. Namely, the operation state that corresponds to the call number of the call process managed by the call control server #2 becomes “being transferred”. Furthermore, the server number 3 is registered in the transfer destination server that is associated with the call number of the call process managed by the call control server #2.

Thereafter, if a return process that returns the transferred call process to the transfer source server has been performed, the server management information 103 indicates the state indicated by a table 134 in which the items of the operation state and the transfer destination server that are associated with the call number of the transferred call process. The table 134 and the table 132 are the same, which indicates that the server management information 103 is returned to the state before the transfer.

If the state in which no call process is allocated to the call control servers 20, the call information 104 indicates the state indicated by a table 141 illustrated in FIG. 24. Then, when the call process is allocated and a communication call starts, as illustrated by a table 142, the call state associated with the call number of each call shifts to “during a communication call” and the incoming call number, the outgoing call number, and the communication call start time of that call are registered. Thereafter, the call information 104 that indicates the state in which a transfer has been occurred is a table 143 and the call information 104 that indicates the state in which a return process of returning the call process has been occurred is a table 144. In this way, the call information is not rewritten even if a transfer or a return process of a call process occurs.

As indicated by a table 111 for the server state management table 101, in the state before a transfer occurs, the operation state of each of the call control servers 20 is “normal”, the transfer destination server address is “NULL”, and the new event is “available” for all of the call control servers.

If a call process is transferred from the call control server #2 to the call control server #3 and is then the call control server #2 is stopped, the server state management table 101 becomes the state indicated by a table 112. Namely, the operation state of the call control server #2 in the server state management table 101 becomes the state of “being stopped”. Furthermore, the address of the call control server #3 is registered in the transfer destination server that is associated with the call number of the call process managed by the call control server #2 in the server state management table 101. Furthermore, because the call control server #2 is stopped, the new event acceptability in the server state management table 101 becomes “not available”.

Thereafter, if the return process of returning the transferred call process to the transfer source server is performed, the server state management table 101 becomes a table 113 in which the state of the stopped call control server #2 is returned to the initial state. The table 113 and the table 111 are the same, which indicates that the server state management table 101 is returned to the state before the transfer.

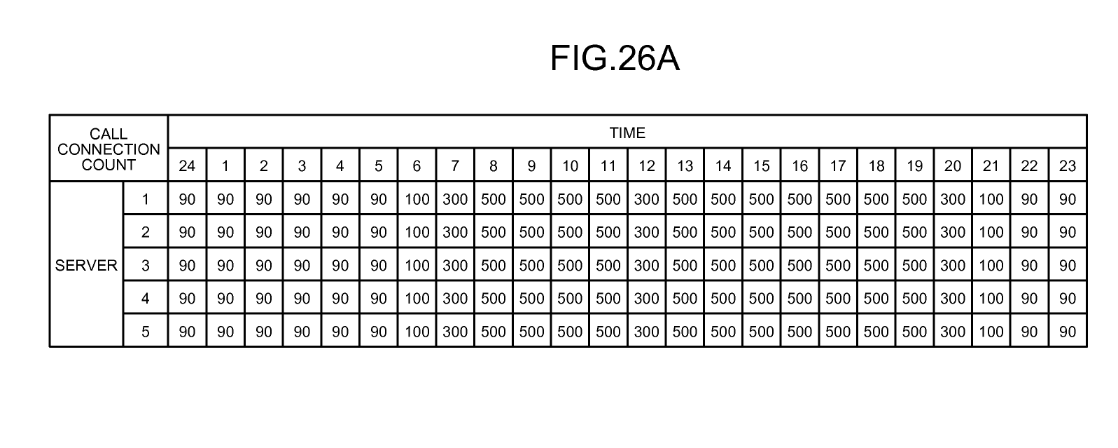

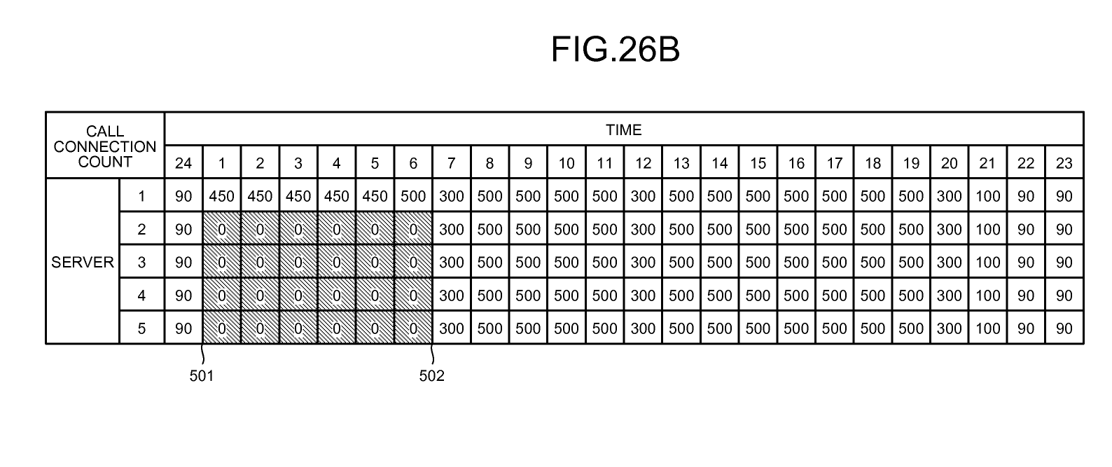

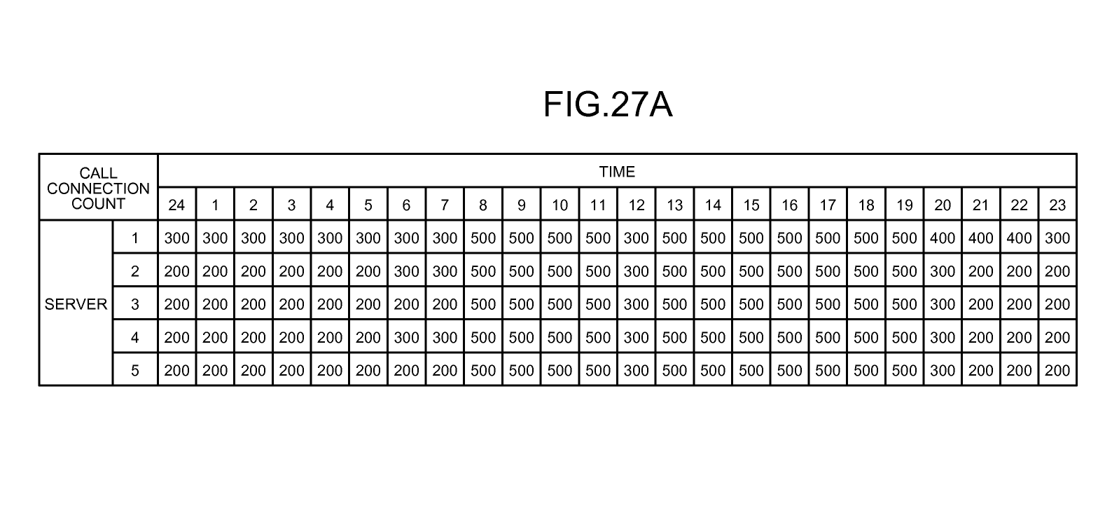

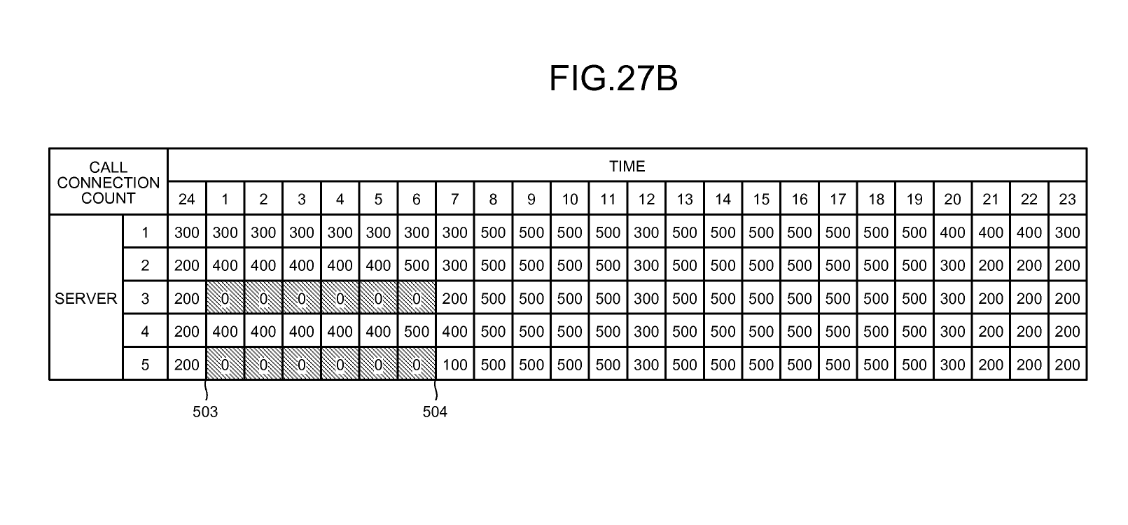

In the following, an example of reducing the electrical power consumption performed by the communication control device according to the embodiment of the present invention will be described with reference to FIGS. 26A and B and FIGS. 27A and B. FIG. 26A is a schematic diagram illustrating an example of the state of call connection when a conventional technology is used. FIG. 26B is a schematic diagram illustrating an example of the state of call connection counts when the communication control device according to the embodiment is used. FIG. 27A is a schematic diagram illustrating another example of the state of call connection when the conventional technology is used. FIG. 27B is a schematic diagram illustrating another example of the state of call connection counts when the communication control device according to the embodiment is used.

FIGS. 26A and B and FIGS. 27A and 27B each illustrate a case in which five call control servers 20 are running. Furthermore, FIGS. 26A and 26B each illustrate a case of comparison when four out of five call control servers 20 can be stopped. Furthermore, FIGS. 27A and 27B each illustrate a case of comparison when two out of five call control servers 20 can be stopped. In FIGS. 26A and 26B and FIGS. 27A and 27B, the horizontal axis indicates the time elapsed in a single day.

As illustrated in FIG. 26A, in a conventional technology, even if the entirety of the call connection count is reduced, the call control server 20 continues the operation all day long without stopping its operation. In contrast, as illustrated in FIG. 26B, when the communication control device 1 according to the embodiment is used, if the number of call processes is decreased, a transfer is started at a timing 501; all of the call processes are concentrated on a single call control server 20; and the operation of the other call control servers 20 is stopped. Thereafter, if the number of call processes is increased, the call control server 20 that was stopped at a timing 502 is started up and a call process is allocated to the five call control servers 20. In this way, between 1:00 and 6:00, four call control servers 20 can be stopped. Consequently, when compared with a case illustrated in FIG. 26A, in a case illustrated in FIG. 26B, the electrical power consumption can be reduced by about 20%.

Furthermore, similarly to a case illustrated in FIG. 26A, in a case illustrated in FIG. 27A, in the conventional technology, even if the entirety of the call connection count is reduced, the call control server 20 continues the operation all day long without stopping its operation. In contrast, as illustrated in FIG. 27B, when the communication control device 1 according to the embodiment is used, if the number of call processes is decreased, a transfer is started at a timing 503 and the call processes managed by two call control servers are transferred to the other two call control servers 20. Then, the two call control servers 20 that do not need to manage the call processes are stopped. Thereafter, if the number of call processes is increased, the two call control servers 20 that are stopped at a timing 504 are started up and the call processes are allocated to five call control servers 20. In this way, between 1:00 and 6:00, two call control servers 20 can be stopped. Consequently, when compared with a case illustrated in FIG. 27A, in a case illustrated in FIG. 27B, the electrical power consumption can be reduced by about 10%.

As described above, if an amount of the load does not exceed a predetermined value even when a call process managed by a certain call control server is transferred to another call control server, the communication control device according to the embodiment stops the certain call control server after the call process has been transferred. By doing so, the number of running servers can be decreased and thus energy saving of the communication system can be improved. However, a call process is a series of processes from the setting of a call to the disconnection of communication and thus the processing time varies depending on the use state. Accordingly, if a call control server is stopped after the managed call process has been completed and no managed call processes is present any more, it is difficult to control the system for appropriate electrical power saving because of uncertain time at which the call control server can be stopped. In contrast, the communication control device according to the embodiment can transfer a call process to another server during a call process that is the time period from when a call is set until when communication is disconnected. Consequently, the communication control device according to the embodiment can eliminate a call process that is managed by the call control server at an appropriate timing and can turn off the power supply of the call control server at an appropriate timing.

Furthermore, if a call control server that is being stopped after a call process has been transferred is present, when the load applied to a running call control server exceeds a predetermined value, the communication control device according to the embodiment starts up the stopped call control server and then returns the call process to the call control server. By doing so, it is possible to avoid the state in which a high load is applied to the call control server and thus a stable operation can be performed on the communication system.

(Hardware Configuration)

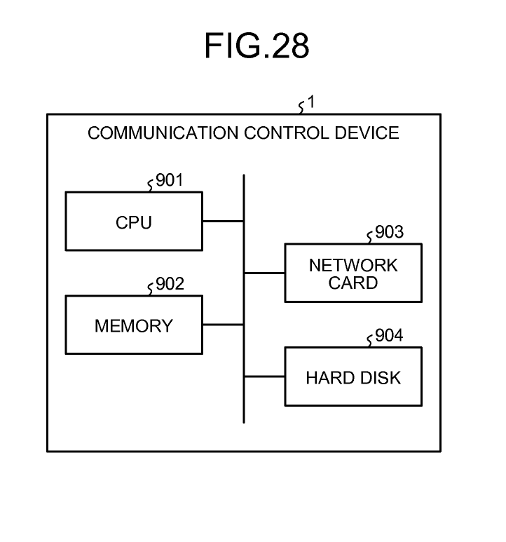

FIG. 28 is a block diagram illustrating the hardware configuration of the communication control device. The communication control device 1 according to the embodiment includes a central processing unit (CPU) 901, a memory 902, a network card 903, and a hard disk 904.

The memory 902, the network card 903, and the hard disk 904 are connected to the CPU 901 via a bus.

The network card 903 and the CPU 901 implement, for example, the function performed by the communication control unit 13 illustrated in FIG. 1.

The hard disk 904 implements, for example, the function performed by the storing unit 10 illustrated in FIG. 1.

The CPU 901, the memory 902, and the hard disk 904 implement the functions performed by the server start-up control unit 11, the assignment control unit 12, the transfer destination server management unit 14, the server stop control unit 15, the call connection count management unit 16, the call information access control unit 17, the call number management unit 18, and the like illustrated in FIG. 1. Specifically, the hard disk 904 stores therein various programs that implement processes performed by the server start-up control unit 11, the assignment control unit 12, the transfer destination server management unit 14, the server stop control unit 15, the call connection count management unit 16, the call information access control unit 17, the call number management unit 18, and the like illustrated in FIG. 1. Then, the CPU 901 reads the various program stored in the hard disk 904, loads the program in the memory 902, and then creates processes that implement the functions described above.

Furthermore, the assignment server 151 and the DB server 152 illustrated in FIG. 10 also have the hardware configuration illustrated in FIG. 28. In this case, the function performed by the communication control unit 191 illustrated in FIG. 10 is implemented by the CPU 901 and the network card 903 in the assignment server 151. Furthermore, the server state management table 101, the call connection information list 102, the server management information 103, and the like illustrated in FIG. 10 are stored in the hard disk 904 in the assignment server 151. Then, the functions performed by the server start-up control unit 11, the assignment control unit 12, the server stop control unit 15, and the like illustrated in FIG. 10 are implemented by the CPU 901, the memory 902, and the hard disk 904 in the assignment server 151. Furthermore, the function performed by the communication control unit 192 illustrated in FIG. 10 can be implemented by the CPU 901 and the network card 903 in the DB server 152. Furthermore, the call information 104 or the like illustrated in FIG. 10 is stored in the hard disk 904 in the DB server 152. Then, the functions performed by the transfer destination server management unit 14, the call connection count management unit 16, the call information access control unit 17, the call number management unit 18, and the like illustrated in FIG. 10 are implemented by the CPU 901, the memory 902, and the hard disk 904 in the DB server 152.

Furthermore, FIG. 28 illustrates the hardware configuration of the communication control device 1; however, the call control server 20 has the same hardware configuration. Accordingly, each piece of the hardware in the call control server 20 will be described by associating the hardware with the hardware of the call control server 20 illustrated in FIG. 28. The function performed by the communication control unit 201 illustrated in FIG. 1 can be implemented by the CPU 901 and the hard disk 904 in the call control server 20. Furthermore, the function performed by the call processing unit 202, the power supply control unit 203, and the like illustrated in FIG. 1 can be implemented by the CPU 901, the memory 902, and the hard disk 904 in the call control server 20.

According to an aspect of an embodiment of the communication control device, the communication control method, and the communication control system disclosed in the present invention, an advantage is provided in that the electrical power consumption of the communication system can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication control device comprising:
a call connection count management unit that acquires
a call connection count that indicates a number of calls that are being processed by each of a plurality of call control servers which performs a call process;
a server stop control unit that selects, on the basis of the call connection count for each of the call control servers, a first call control server from among the call control servers, that transfers a call process that is allocated to the first call control server to another call control server, and that stops the first call control server when no call process allocated to the first call control server is present; and
an assignment control unit that receives a processing request related to a call process and that assigns, when the call control server that performs the call process associated with the processing request is being stopped by the server stop control unit, the processing request to the other call control server to which the call process associated with the processing request is transferred by the server stop control unit.

2. The communication control device according to claim 1, wherein the server stop control unit stores therein a server stop threshold in advance, selects the first call control server on the basis of the call connection count for each of the call control servers, transfers, when the call process allocated to the first call control server is transferred to the other call control server and the load applied to the other call control server is equal to or less than the server stop threshold, the call process allocated to the first call control server to the other call control server, and stops the first call control server when no call process allocated to the first call control server is present.

3. The communication control device according to claim 1, further comprising a server start-up control unit that stores therein a server start-up threshold in advance and that starts up, when the load applied to one of the call control servers which are being stopped exceeds the server start-up threshold.

4. The communication control device according to claim 3, wherein the server start-up control unit transfers one of the call processes allocated to one of the call control servers, whose load exceeds the server start-up threshold, to the call control server that was started up.

5. The communication control device according to claim 4, wherein, when a transferred call process that has been transferred from the started up call control server is present from among the call processes that are allocated to the call control servers whose load exceeds the server start-up threshold, the server start-up control unit returns the transferred call process to the started up call control server that is the transfer source of the transferred call process.

6. A communication control method comprising:
acquiring a call connection count that indicates a number of calls that are being processed by a plurality of call control servers each of which performs a call process;
selecting, on the basis of the call connection count for each of the call control servers, a first call control server from among the call control servers and transferring a call process that is allocated to the first call control server to another call control server;
stopping the first call control server when no call process allocated to the first call control server is present; and
receiving a processing request related to a call process and assigning, when the call control server that performs the call process associated with the processing request is being stopped by the server stop control unit, the processing request to the other call control server to which the call process associated with the processing request is transferred.

7. A communication control system comprising:
a plurality of call control servers; and
a communication control device, wherein
a call control server includes
a call processing unit that performs a process on a call, and
a stop control unit that stops the call control server, and
the communication control device includes
a call connection count management unit that acquires a call connection count that indicates a number of calls that are being processed by each of the call control servers,
a server stop control unit that selects, on the basis of the call connection count for each of the call control servers, a first call control server from among the call control servers, that transfers a call process that is allocated to the first call control server to another call control server, and that instructs to stop the stop control unit in the first call control server when no call process allocated to the first call control server is present, and
an assignment control unit that receives a processing request related to a call process and that assigns, when the call control server that performs the call process associated with the processing request is being stopped, the processing request to the other call control server to which the call process associated with the processing request is transferred by the server stop control unit.
